(19) United States
(12) Patent Application Publication
(10) Pub. No.: US 2017/0264388 A1
(43) Pub. Date: Sep. 14, 2017

(54) NETWORK MANAGEMENT METHOD, NETWORK MANAGING DEVICE, AND RECORDING MEDIUM

(71) Applicant: FUJITSU LIMITED, Kawasaki-shi (JP)

(72) Inventors: Hiroshi Watanabe, Kawasaki (JP); HIDEKI KAJITANI, Hakusan (JP); Yusuke Kato, Kanazawa (JP); Hisatake Do, Kawasaki (JP); Hiroko Yokota, Toyama (JP); Hideyuki Sora, Takaoka (JP)

(73) Assignee: FUJITSU LIMITED, Kawasaki-shi (JP)

(21) Appl. No.: 15/421,890

(22) Filed: Feb. 1, 2017

(30) Foreign Application Priority Data
Mar. 9, 2016 (JP) 2016-046301

(51) Int. Cl. H04J 14/02

(52) U.S. Cl. CPC H04J 14/0227; H04J 14/021

(57) ABSTRACT

A network management method executed by a processor included in a network managing device configured to manage a network in which a plurality of wavelength-multiplexed optical signals is transmitted, the method includes determining an active path and an auxiliary path for each of the plurality of optical signals; allocating, for each of links coupling adjacent nodes included in the network to each other, frequency bands to be used for the optical signals to the active paths for the optical signals so that frequency bands for the maximum rates of transmitting the optical signals do not overlap each other; and allocating, for each of the links, unallocated frequency bands within the frequency bands for the maximum transmission rates to the auxiliary paths for the optical signals.

### CROSS-REFERENCE TO RELATED APPLICATION

This application is based upon and claims the benefit of priority of the prior Japanese Patent Application No. 2016-046301, filed on Mar. 9, 2016, the entire contents of which are incorporated herein by reference.

### FIELD

The embodiment discussed herein is a network management method, a network managing device, and a recording medium.

### BACKGROUND

Wavelength-division multiplexing (WDM) that multiplexes multiple optical signals with different wavelengths and transmits the wavelength-multiplexed optical signals is known. A transmitting device that uses WDM is a reconfigurable optical add and drop multiplexer (ROADM), for example. A network managing device that manages a network of transmitting devices of this type allocates frequency bands to paths (hereinafter referred to as “optical paths”) for optical signals between the transmitting devices.

International Telecommunication Union Telecommunication Standardization Sector (ITU-T) Recommendation G.694.1 defines the allocation of frequency bands to optical paths based on a grid of fixed frequency intervals of 100 MHz or 50 MHz. In the allocation, however, the frequency bands having the same width are allocated regardless of the amounts of traffic in the optical paths. Thus, the efficiency of using the frequency bands is low.

An elastic optical network technique for allocating optimal optical resources to optical paths based on conditions such as transmission distances and transmission capacities is being researched and developed. In the elastic optical network technique, frequency bands are allocated based on a flexible grid with variable widths, instead of the aforementioned grid of the fixed widths (refer to, for example, International Publication Pamphlet No. WO2015/033545). The frequency bands, therefore, may be allocated to optical paths based on the amounts of traffic in the optical paths.

Thus, the network managing device may improve the efficiency of using frequency bands by reducing the intervals of the flexible grid for the optical paths, compared with the grid of the fixed widths.

When the amount of traffic in an optical path increases due to an increase in the number of communication lines or the like, the network managing device extends a frequency band allocated to the optical path. However, if the frequency band after the extension overlaps an adjacent frequency band for another optical path, an error occurs in an optical signal and the frequency band is not extended.

If the frequency band for the optical path is changed so that the frequency band does not overlap the frequency band for the other optical path, the frequency band may be extended. In this case, however, the frequency band for the optical path is temporarily deleted, the transmission of the optical signal is temporarily stopped and a communication service is interrupted. In addition, if a frequency band for the maximum rate of transmitting the optical signal is allocated in advance, the frequency bands for the optical paths do not overlap each other upon the extension. However, the advantage of the flexible grid is lost and the efficiency of using the frequency bands is reduced.

### SUMMARY

According to an aspect of the invention, a network management method executed by a processor included in a network managing device configured to manage a network in which a plurality of wavelength-multiplexed optical signals is transmitted, the method includes determining an active path and an auxiliary path for each of the plurality of optical signals; allocating, for each of links coupling adjacent nodes included in the network to each other, frequency bands to be used for the optical signals to the active paths for the optical signals so that frequency bands for the maximum rates of transmitting the optical signals do not overlap each other; and allocating, for each of the links, unallocated frequency bands within the frequency bands for the maximum transmission rates to the auxiliary paths for the optical signals.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of a network system;

FIG. 2 is a configuration diagram illustrating an example of each of ROADM devices;

FIG. 3 is a diagram describing a process of extending a frequency band according to a comparative example;

FIG. 4 is a diagram describing the allocation of frequency bands according to an embodiment;

FIG. 5 is a diagram describing a process of extending a frequency band usable for an active path according to the embodiment;

FIG. 6 is a diagram describing a process of extending a frequency band usable for an auxiliary path according to the embodiment;

FIG. 7 is a configuration diagram illustrating an example of a managing server;

FIG. 8 is a diagram illustrating an example of a section table and a band table;

FIG. 9 is a diagram describing definitions of symbols and parameters indicated in the section table and the band table.

FIG. 10 is a flowchart of an example of a process of setting an active path;

FIG. 11 is a flowchart of an example of a process of setting an auxiliary path;

FIG. 12 is a flowchart of an example of a process of extending a frequency band usable for an active path;

FIG. 13 is a flowchart of an example of a process of extending a frequency band usable for an auxiliary path;

FIG. 14 is a flowchart of an example of a process of deleting an active path;

FIG. 15 is a flowchart of an example of a process of deleting an auxiliary path;

FIG. 16 is a diagram describing an example of operations of managing frequency bands for active and auxiliary paths;

FIG. 17 is a diagram describing the example of the operations of managing the frequency bands for the active and auxiliary paths;

FIG. 18 is a diagram describing the example of the operations of managing the frequency bands for the active and auxiliary paths;

FIG. 19 is a diagram describing the example of the operations of managing the frequency bands for the active and auxiliary paths;

FIG. 20 is a diagram describing the example of the operations of managing the frequency bands for active and auxiliary paths;

FIG. 21 is a diagram describing the example of the operations of managing the frequency bands for the active and auxiliary paths;

FIG. 22 is a diagram describing the example of the operations of managing the frequency bands for the active and auxiliary paths;

FIG. 23 is a diagram illustrating an example of active and auxiliary paths; and

FIG. 24 is a diagram illustrating the state of the allocation of active and auxiliary paths according to the comparative example and the state of the allocation of active and auxiliary paths according to the embodiment.

### DESCRIPTION OF EMBODIMENT

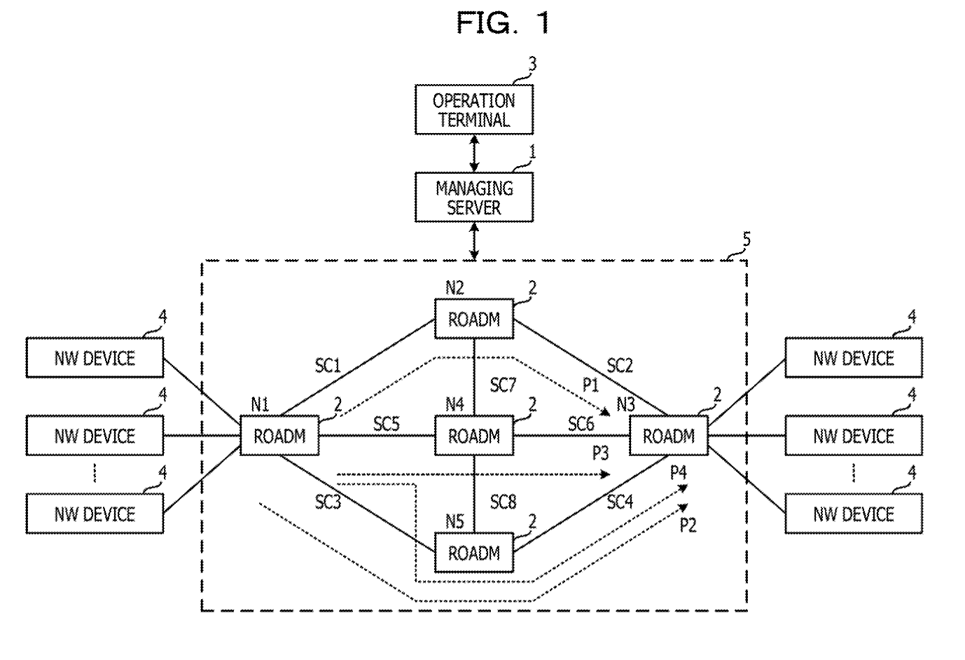

FIG. 1 is a configuration diagram illustrating an example of a network system. The network system includes a managing device 1, a plurality of ROADM devices 2, and an operation terminal 3. The managing device 1 is an example of a network managing device. The operational terminal 3 is a personal computer or the like. The operational terminal 3 functions as a human machine interface (HMI) to be used by an operator to monitor and control the ROADM devices 2. The operation terminal 3 is connected to the managing device 1 via a data communication network (DCN) or the like.

The ROADM devices 2 are installed in nodes N1 to N5 within a network 5 to be managed by the managing server 1. Each of the ROADM devices 2 is an example of a transmitting device. Each of the ROADM devices 2 wavelength-multiplexes optical signals and transmits the wavelength-multiplexed optical signals. The ROADM devices 2 are connected to each other via optical fibers that are transmission paths.

Each of the ROADM devices 2 of the nodes N1 and N3 is connected to a plurality of network devices (NW devices) 4 of a client network. The NW devices 4 are transmitting devices, each of which has, installed therein, a Layer 2 switch, a router, and a Layer 2 switch function. The NW devices 4, however, are not limited to this.

The network 5 functions as a relay network that relays communication between the NW devices 4. Thus, paths (optical paths) P1 and P2 that contain communication lines (L2 paths) for the NW devices 4 are provided between the ROADM devices 2. For example, the path P1 extends through the ROADMs device 2 of the nodes N1, N2, and N3 in this order, while the path P2 extends through the ROADMs device 2 of the nodes N1, N5, and N3 in this order. The path P3 extends through the ROADMs device 2 of the nodes N1, N4, and N3 in this order, for example. The path P4 extends through the ROADMs device 2 of the nodes N1, N4, N5, and N3 in this order, for example.

Optical signals are transmitted in the paths P1 to P4. If different optical signals are transmitted in overlapping portions of the paths 1 to 4, the optical signals are wavelength-multiplexed by a ROADM device 2 within a transmission path including the overlapping portions. For example, optical signals of the paths P3 and P4 are wavelength-multiplexed in a transmission path between the nodes N1 and N4 and transmitted.

The managing server 1 is a network element operating system (NE-OpS), for example. The managing device 1 manages the network 5 in which multiple wavelength-multiplexed optical signals are transmitted. The managing server 1 is connected to the ROADM devices 2 within the network 5 via a DCN or the like. The managing server 1 sets the paths P1 to P4 in the network 5 based on an operation of the operation terminal 3 and manages the paths P1 to P4. The managing server 1 defines, as sections SC1 to SC8, transmission paths between the ROADM devices 2 of the adjacent nodes N1 to N5. Then, the managing server 1 sets and manages the paths P1 to P4 for each of the sections SC1 to SC8.

For example, the section SC1 is defined between the ROADM devices 2 of the nodes N1 and N2. The section SC2 is defined between the ROADM devices 2 of the nodes N2 and N3. Each of the sections SC1 to SC8 corresponds to a link that connects adjacent nodes among the nodes N1 to N5 to each other.

The managing server 1 allocates frequency bands to the paths P1 to P4 for each of the sections SC1 to SC8. The frequency bands to be allocated are determined based on frequency bands of communication lines contained in the paths P1 to P4. Alternatively, the managing server 1 may allocate wavelength bands instead of the frequency bands.

The managing server 1 determines an active path and an auxiliary path for each optical signal. The active path is any of the paths P1 to P4 and is used for the transmission of the optical signal. The auxiliary path is any of the paths P1 to P4 and is used when a ROADM device 2 through which the active path extends or a transmission path included in the active path fails. A ROADM device 2 may autonomously switch the active path and the auxiliary path to each other. Alternatively, the managing server 1 may switch the active path and the auxiliary path to each other.

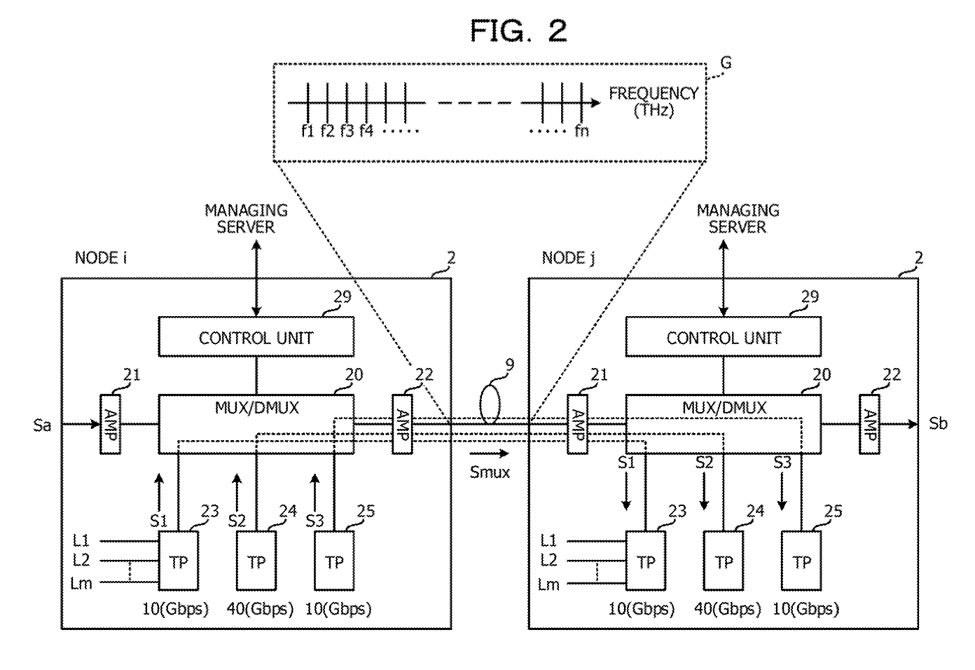

FIG. 2 is a configuration diagram illustrating an example of each of the ROADM devices 2. Specifically, FIG. 2 illustrates, as an example, ROADM devices 2 of a pair of adjacent nodes i and j (i and j are positive integers).

Each of the ROADM devices 2 includes a multiplexing and demultiplexing unit (MUX/DMUX) 20, amplifiers (AMPs) 21 and 22, transporters (TPs) 23 to 25, and a control unit 29. The multiplexing and demultiplexing unit 20, the amplifiers 21 and 22, the transporters 23 to 25, and the control unit 29 are configured as a board on which optical parts, electronic circuit parts, and the like are mounted.

Each of the amplifiers 21 and 22 includes an optical amplifier that amplifies an optical signal (wavelength-multiplexed signal). The optical amplifiers are provided for directions in which optical signals are transmitted. The amplifier 22 of the ROADM device 2 of the node i is connected to the amplifier 21 of the ROADM device 2 of the node j via an optical fiber 9. Although the amplifiers 21 and 22 for two paths (transmission paths) are illustrated in FIG. 2, amplifiers 21 and 22 are actually provided for paths on which the ROADM devices 2 are connected. Although the single optical fiber 9 is illustrated, optical fibers 9 are actually provided for the directions in which optical signals are transmitted.

The TPs 23 to 25 are transceivers that transmit and receive optical signals S1 to S3 with different wavelengths. Each of the TPs 23 to 25 is connected to one or more communication lines L1, L2, . . . , Lm (m is a positive integer). The TPs 23 to 25 transmit and receive, as the optical signals S1 to S3, data of the communication lines L1, L2, . . . , Lm. Although communication lines L1, L2, . . . , Lm of the TPs 23 are illustrated, each of the TPs 24 and 25 is connected to one or more communication lines in the same manner as the TPs 23. The TPs 23 to 25 transmit and receive the optical signals S1 to S3 via the multiplexing and demultiplexing units 20.

The TPs 23 to 25 have respective transmission rates, respectively. For example, the transmission rates of the TPs 23 and 25 are 10 Gbps, while the transmission rates of the TPs 24 are 40 Gbps. Thus, the maximum rate of transmitting the optical signal S1 by the TPs 23 and the maximum rate of transmitting the optical signal S3 by the TPs 25 are 10 Gbps. The maximum rate of transmitting the optical signal S2 by the TPs 24 is 40 Gbps.

Each of the multiplexing and demultiplexing units 20 includes an optical section such as a wavelength selective switch (WSS) or an optical coupler. Each of the multiplexing and demultiplexing units 20 executes wavelength multiplexing an optical signal to multiplex the optical signal and a signal having a specific wavelength. In addition, each of the multiplexing and demultiplexing units 20 separates a signal having a specific wavelength from a wavelength-multiplexed signal.

For example, in the ROADM device 2 of the node i, the multiplexing and demultiplexing unit 20 executes the wavelength multiplexing on the optical signals S1 to S3 received from the TPs 23 to 25 to multiplex the optical signals S1 to S3 and a wavelength multiplexing optical signal Sa. A wavelength-multiplexed optical signal Smux obtained by the multiplexing of the optical signals S1 to S3 and the wavelength multiplexing optical signal Sa is output to the optical fiber 9 via the amplifier 22.

In the ROADM device 2 of the node j, the multiplexing and demultiplexing unit 20 separates the optical signals S1 to S3 from the wavelength-multiplexed optical signal Smux received from the amplifier 21 and outputs the optical signals S1 to S3 to the TPs 23 to 25. A wavelength multiplexing optical signal Sb after the demultiplexing of the optical signals 51 to S3 is output to the ROADM device 2 of another node via the amplifier 22.

In this manner, the optical signals 51 to S3 are transmitted and received between the ROADM device 2 of the node i and the ROADM device of the node j. The managing server 1 sets individual paths for the optical signals 51 to S3, as indicated by dotted lines. In this case, the managing server 1 divides a frequency band of the optical fiber 9 for a section between the nodes i and j into a number n (n is a positive integer) of frequency bands f1 to fn (THz) and manages the frequency bands f1 to fn. Then, the managing server 1 allocates the frequency bands to active and auxiliary paths for the optical signals S1 to S3.

The managing server 1 sets frequencies in the control units 29 of the ROADM devices 2 based on the results of the allocation. Each of the control units 29 includes a control processing unit (CPU) circuit and the like and communicates with the managing server 1. The control units 29 set wavelengths in the multiplexing and demultiplexing units 20 based on the setting of the frequencies.

For example, in the ROADM device 2 of the node i, the control unit 29 sets the wavelengths of the optical signals S1 to S3 in the WSS or the like in order to cause the optical signals S1 to S3 to be wavelength-multiplexed. In the ROADM device 2 of the node j, the control unit 29 sets the wavelengths of the optical signals S1 to S3 in the WSS or the like in order to separate the optical signals S1 to S3 from the wavelength-multiplexed signal Smux.

If communication lines are newly connected to the TPs 23 to 25, the managing server 1 extends frequency bands allocated to target active and auxiliary paths in order to increase the transmission bands for the optical signals.

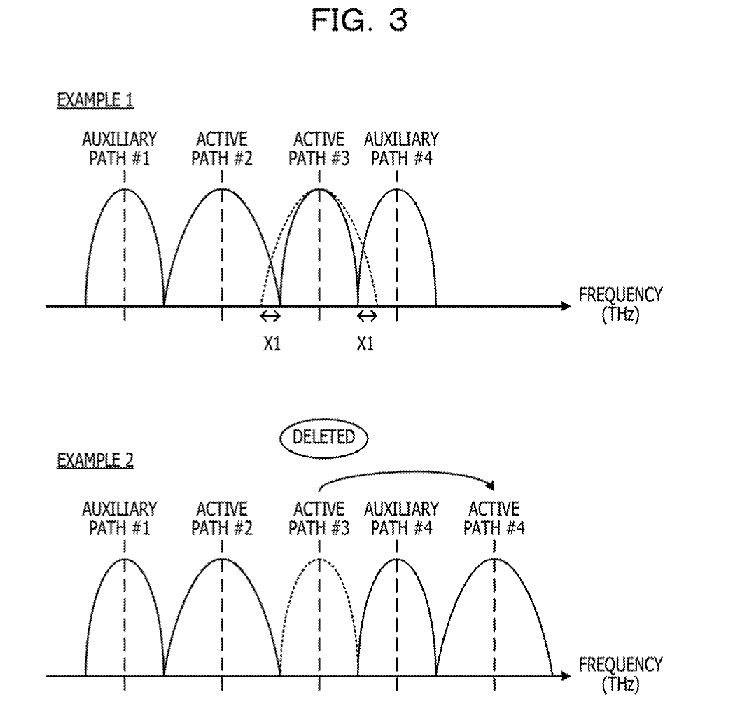

FIG. 3 describes a process of extending an active band according to a comparative example. FIG. 3 illustrates the frequency spectra of optical signals within active paths #2 and #3 and frequency spectra of optical signals within auxiliary paths #1 and #4 in the same section. The widths of the frequency spectra indicate frequency bands allocated to the active paths #2 and #3 and frequency bands allocated to the auxiliary paths #1 and #4. The frequency bands allocated to the active paths #2 and #3 and the frequency bands allocated to the auxiliary paths #1 and #4 are set based on a flexible grid and adjacent to each other.

In Example 1, the frequency band allocated to the active path #3 is extended, as indicated by a dotted line. Extended frequency bands X1, however, overlap the frequency bands allocated to the active and auxiliary paths #2 and #4 adjacent to the frequency bands X1. Thus, an error occurs in optical signals within the active paths #2 and #3. When the path switching is executed so that an optical signal starts to be transmitted in the auxiliary path #4, an error occurs in the optical signal.

In Example 2, the frequency band allocated to the active path #2 is changed to a frequency band on the high frequency side of the auxiliary path #4 so that the frequency band allocated to the active path #2 does not overlap the frequency band allocated to the auxiliary path #4 after the extension (refer to an arrow). In this case, an error does not occur in an optical signal, but the frequency band allocated to the active path #3 is temporarily deleted (refer to a dotted line). Thus, the transmission of the optical signal is temporarily stopped and a communication service is interrupted.

In the aforementioned Example 1, if a frequency band for the maximum rate of transmitting the optical signal is allocated to the active path #2 in advance, the frequency bands allocated to the adjacent active and auxiliary paths #2 and #4 upon the extension do not overlap each other. However, an advantage of the flexible grid is lost and the efficiency of using the frequency bands is reduced.

In the embodiment, frequency bands for use are allocated to active paths so that frequency bands for the maximum rates of transmitting optical signals do not overlap each other. Unallocated frequency bands that are within the frequency bands for the maximum transmission rates are allocated to auxiliary paths. Thus, the efficiency of using the frequency bands is improved.

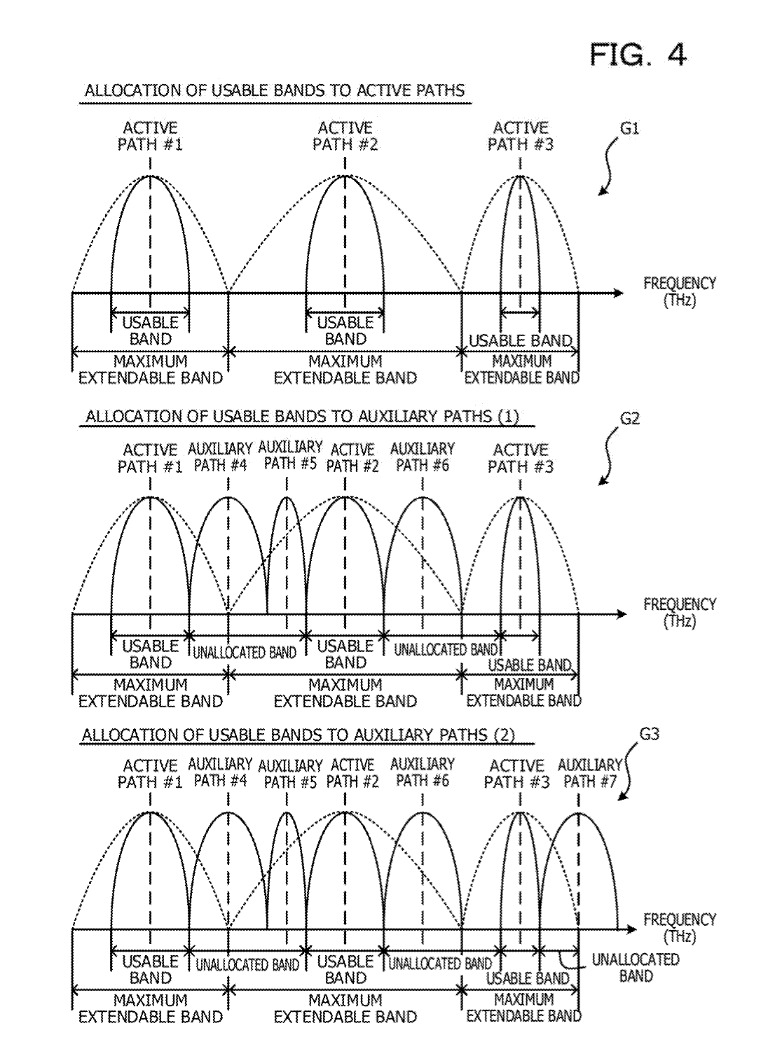

FIG. 4 describes the allocation of frequency bands according to the embodiment. An example illustrated in FIG. 4 assumes that active paths #1 to #3 and auxiliary paths #4 to #7 are provided in the same section.

In FIG. 4, “usable bands” indicate frequency bands usable for optical signals within the active paths #1 to #3, and “maximum extendable bands” indicate frequency bands for the maximum rates of transmitting the optical signals in the active paths #1 to #3. Specifically, the usable bands are the frequency bands actually usable for the optical signals and are determined based on the amounts of traffic in communication lines L1 to Lm contained in the active paths #1 to #3 and the like. Frequency bands usable for the auxiliary paths #4 to #7 are the same as frequency bands usable for active paths for which the auxiliary paths #4 to #7 are provided.

The maximum extendable bands are frequency band ranges in which the usable bands are able to be extended (or reduced). The maximum extendable bands are determined based on the transmission rates (physical bands) of the transponders that transmit and receives optical signals via the active paths #1 to #3. For example, if an optical signal is transmitted and received by the TPs 23 illustrated in FIG. 2 via the active path #1, the rate of transmitting the optical signal is 10 Gbps. Thus, the maximum extendable band for the active path #1 is a frequency band for 10 Gbps. If an optical signal is transmitted and received by the TPs 24 illustrated in FIG. 2 via the active path #2, the maximum rate of transmitting the optical signal is 40 Gbps. Thus, the maximum extendable band for the active path #2 is a frequency band for 40 Gbps. Frequency spectra of the maximum extendable bands are illustrated by dotted lines.

The managing server 1 allocates usable bands to the active paths #1 to #3 so that the maximum extendable bands for the active paths #1 to #3 do not overlap each other, as indicated by a symbol G1. Thus, unallocated frequency bands (hereinafter referred to as “unallocated bands”) are ensured between the bands usable for the active paths #1 to #3.

Specifically, the managing server 1 allocates the usable bands to the active paths #1 to #3 so that the maximum extendable bands for the active paths #1 to #3 are adjacent to each other. Thus, a pointless available band does not exist between the maximum extendable bands for the active paths #1 to #3, and the efficiency of using the frequency bands is improved.

Next, the managing server 1 allocates unallocated bands within the maximum extendable bands to the auxiliary paths #4 to #6, as indicated by a symbol G2. In this example, unallocated bands between the active paths #1 and #2 are allocated to the auxiliary paths #4 and #5, and an unallocated band between the active paths #2 and #3 is allocated to the auxiliary path #6. The unallocated bands are frequency bands that are not used in a normal state and are used when the bands usable for the active paths #1 to #3 are extended. In other words, the unallocated bands are reserved for the active paths #1 to #3.

The bands usable for the auxiliary paths #4 to #6 do not overlap the bands usable for the active paths #1 to #3. Thus, even if optical signals are transmitted in the auxiliary paths #4 to #6 due to the path switching upon the occurrence of a failure, an error does not occur in the optical signals and a communication service is not affected.

When the bands usable for the active paths #1 to #3 are extended, the extended frequency bands overlap the bands usable for the auxiliary paths #4 to #6, but do not overlap the other bands usable for the active paths #1 to #3. An optical signal is not transmitted in the auxiliary paths #4 to #6 unless the path switching is executed due to the occurrence of a failure. Thus, the bands usable for the active paths #1 to #3 may be extended without an error in the optical signals, and the communication service is not affected.

Thus, by allocating the unallocated bands within the maximum extendable bands to the auxiliary paths #4 to #6, the unallocated bands are effectively used and the efficiency of using the frequency bands is improved.

Next, the managing server 1 allocates a usable band to an auxiliary path #7, as indicated by a symbol G3. The unallocated bands between the active paths #1 and #2 are already allocated to the auxiliary paths #4 and #5, and the unallocated band between the active paths #2 and #3 is already allocated to the auxiliary path #6. Thus, the unallocated band on the high frequency side of the active path #3 is allocated to the auxiliary path #7. If an unallocated band does not exist between the active paths #1 to #3, the unallocated band on the high frequency side of the active path #3 is allocated to the auxiliary path #7. An unallocated band on the low frequency side of the active path #1 may be allocated to the auxiliary path #7, instead of the allocation of the unallocated band on the high frequency side of the active path #3.

For example, if communication lines L1 to Lm are newly contained in the active paths #1 to #3, the managing server 1 extends the bands usable for the active paths #1 to #3. A process of extending a band usable for an active path is described below with an example in which the band usable for the active path #2 illustrated in FIG. 4 is extended.

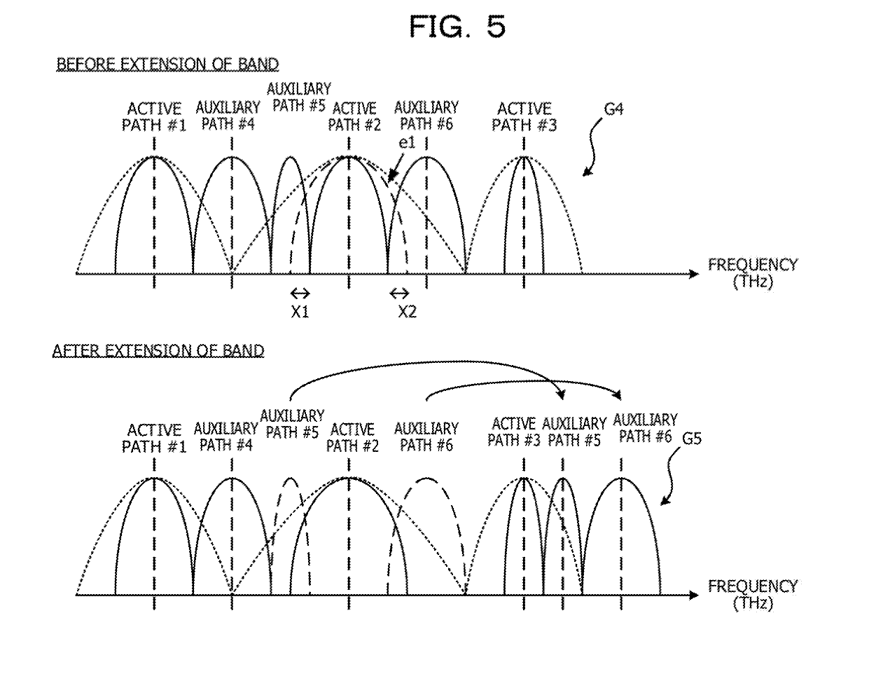

FIG. 5 describes a process of extending the band usable for the active path #2 according to the embodiment. A symbol G4 indicates a state before the extension of the band usable for the active path #2. A symbol G5 indicates a state after the extension of the band usable for the active path #2.

The managing server 1 extends the band allocated to and usable for the active path #2, as indicated by a symbol e1. Extended bands X1 and X2 usable for the active path #2 overlap the bands allocated to the auxiliary paths #5 and #6. Thus, the bands usable for the auxiliary paths #5 and #6 are changed so as not to overlap the extended bands X1 and X2 usable for the active path #2, as indicated by an arrow.

The managing server 1 changes the bands usable for the auxiliary paths #5 and #6 to an unallocated band and an available band that are on the high frequency side of the band usable for the active path #3. Specifically, the managing server 1 temporarily deletes the bands usable for the auxiliary paths #5 and #6 and allocates, to the auxiliary paths #5 and #6, the frequency bands to which the bands usable for the auxiliary paths #5 and #6 are changed.

Unless the path switching is executed, an optical signal is not transmitted in the auxiliary paths #5 and #6. Thus, if the path switching is not executed, the managing server 1 may change the bands usable for the auxiliary paths #5 and #6 and extend the band usable for the active path #2 without affecting the communication service. Since the bands usable for the auxiliary paths #5 and #6 are changed so as not to overlap the extended bands X1 and X2 usable for the active path #2, the managing server 1 may prepare for the transmission of optical signals in the auxiliary paths #5 and #6 upon the path switching.

When the bands usable for the active paths #1 to #3 are to be extended by the managing server 1, the managing server 1 extends the bands usable for the auxiliary paths provided for the active paths #1 to #3. A process of extending a band usable for an auxiliary path is described below with an example in which the band usable for the auxiliary path #4 is extended.

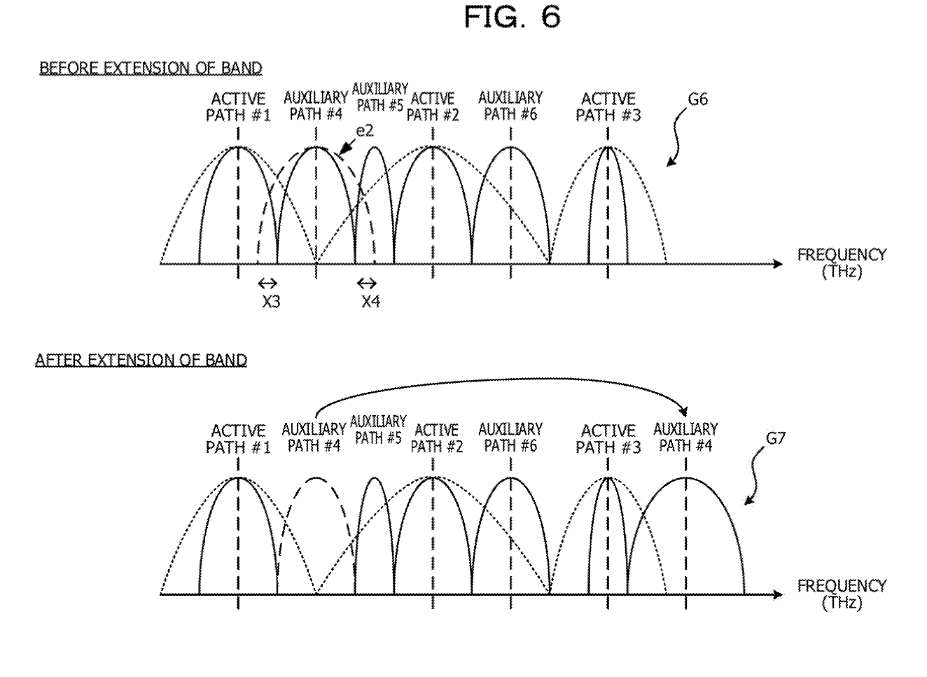

FIG. 6 describes a process of extending the band usable for the auxiliary path #4 according to the embodiment. A symbol G6 indicates a state before the band usable for the auxiliary path #4 is extended. A symbol G7 indicates a state after the band usable for the auxiliary path #4 is extended.

As indicated by a symbol e2, in order to extend the band allocated to and usable for the auxiliary path #4, the managing server 1 determines whether or not the usable band after the extension overlaps a band allocated to and usable for another active or auxiliary path. Specifically, before the band allocated to and usable for the auxiliary path #4 is extended, the managing server 1 determines whether or not the usable band after the extension overlaps the band allocated to and usable for the other active or auxiliary path. A method for the determination is described later.

As a result of the determination, the managing server 1 determines that bands X3 and X4 usable for the auxiliary path #4 after the extension overlap the bands allocated to and usable for the active and auxiliary paths #1 and #5. Thus, the managing server 1 changes the band usable for the auxiliary path #4 and to be extended so that the bands X3 and X4 usable for the auxiliary path #4 after the extension do not overlap the bands allocated to and usable for the active and auxiliary paths #1 and #5.

The managing server 1 changes the band usable for the auxiliary path #4 to an unallocated and available band on the high frequency side of the band usable for the active path #3 as an example. Specifically, the managing server 1 temporarily deletes the band usable for the auxiliary path #4 and allocates, to the auxiliary path #4, the frequency band to which the band usable for the auxiliary path #4 is changed. In this case, the managing server 1 allocates, to the auxiliary path #4, the frequency band obtained by adding the usable bands X3 and X4 obtained by the extension to the original usable band.

Unless the path switching is executed, an optical signal is not transmitted in the auxiliary path #4. Thus, if the path switching is not executed, the managing server 1 may change the band usable for the auxiliary path #4, extend the band usable for the auxiliary path #4 without affecting the communication service, and prepare for the transmission of an optical signal in the auxiliary path #4 upon the path switching.

Next, the configuration of the managing server 1 is described.

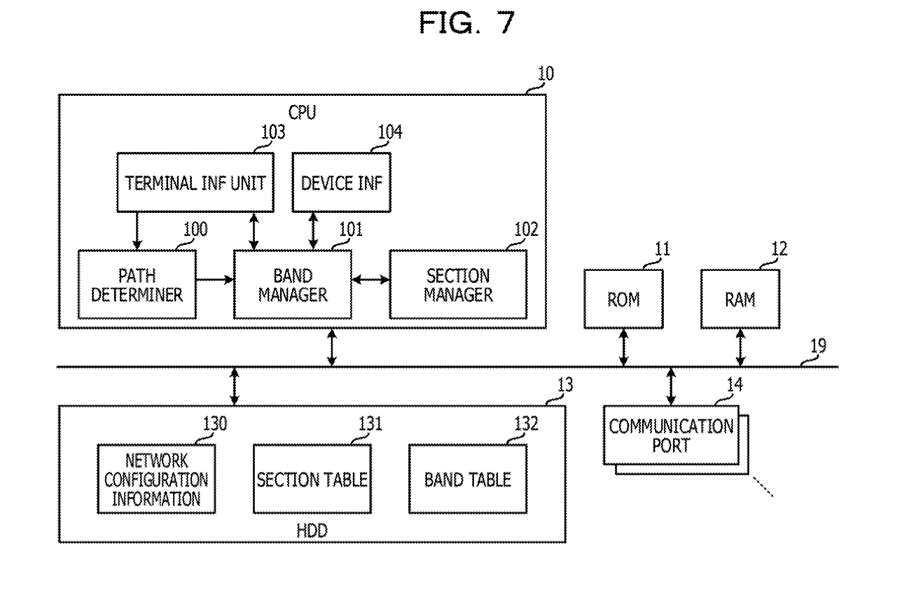

FIG. 7 is a configuration diagram illustrating an example of the managing server 1. The managing server 1 includes a CPU 10, a read only memory (ROM) 11, a random access memory (RAM) 12, a hard disk drive (HDD) 13, and communication ports 14. The CPU 10 is connected to the ROM 11, the RAM 12, the HDD 13, and the communication ports 14 via a bus 19 so that the CPU 10, the ROM 11, the RAM 12, the HDD 13, and the communication ports 14 transmit and receive signals to and from each other via the bus 19. The CPU 10 is an example of a computer.

A program for driving the CPU 10 is stored in the ROM 11. The RAM 12 functions as a working memory of the CPU 10. The multiple communication ports 14 transmit and receive packets to and from the ROADM devices 2 and the operation terminal 3.

When the CPU 10 reads the program from the ROM 11, a path determiner 100, a band manager 101, a section manager 102, a terminal interface (terminal INF) 103, and a device interface (device INF) 104 are formed as functions. In the HDD 13, network configuration information 130, a section table 131, and a band table 132 are stored.

The terminal INF 103 communicates with the operation terminal 3 via a communication port 14. The terminal INF 103 outputs an instruction to the path determiner 100 and the band manager 101 based on information on an operation of the operation terminal 3.

The path determiner 100 is an example of a determiner. The path determiner 100 determines an active path and an auxiliary path for each of optical signals. The path determiner 100 calculates a path connecting ROADM devices 2 of start and end nodes among the nodes N1 to N5 to each other based on the network configuration information 130 and information input from the operation terminal 3 and indicating the start and end nodes among the nodes N1 to N5. The network configuration information 130 includes information indicating relationships between the nodes N1 to N5 and sections SC1 to SC8 included in the network 5 illustrated in FIG. 1 and information indicating the transmission rates of the TPs 23 to 25.

The path determiner 100 determines an active path and an auxiliary path based on the calculated path. The path determiner 100 outputs information on the determined active path and the determined auxiliary path to the band manager 101.

The band manager 101 manages, for each of the sections, frequency bands for the active and auxiliary paths. The band manager 101 is configured to set, change, and delete the active and auxiliary paths in accordance with operations of the operation terminal 3 by the operator.

The band manager 101 is an example of an allocator. The band manager 101 allocates, for each of the sections SC1 to SC8, frequency bands to be used for optical signals to active paths for the optical signals so that frequency bands for the maximum rates of transmitting the optical signals do not overlap each other. Specifically, the band manager 101 allocates, to the active paths, the usable bands so that maximum extendable bands for the active paths do not overlap each other, as described with reference to FIG. 4. More specifically, the band manager 101 allocates, to the active paths for the optical signals, the frequency bands to be used for the optical signals so that the frequency bands for the maximum rates of transmitting the optical signals are adjacent to each other.

The band manager 101 allocates, for each of the sections SC1 to SC8, unallocated frequency bands within the frequency bands for the maximum transmission rates to the auxiliary paths for the optical signals. Specifically, the band manager 101 allocates the unallocated frequency bands within the maximum extendable bands to the auxiliary paths, as described with reference to FIG. 4.

For example, if communication lines L1 to Lm are newly contained in the active paths #1 to #3, the band manager 101 extends the frequency bands allocated to the active paths based on an instruction from the operation terminal 3. If at least a part of the extended frequency bands allocated to the active paths overlaps a frequency band allocated to an auxiliary path, the band manager 101 changes the frequency band allocated to the auxiliary path so that the frequency band allocated to the auxiliary path does not overlap the frequency bands allocated to the active paths. Specifically, as described with reference to FIG. 5, if at least a part of the extended band usable for the active path #2 overlaps a usable band allocated to an auxiliary path, the managing server 1 changes the usable band allocated to the auxiliary path so that the usable band allocated to the auxiliary path does not overlap the extended band usable for the active path #2.

When a frequency band allocated to an active path is to be extended, the band manager 101 extends a frequency band allocated to an auxiliary path provided for the active path. When a frequency band allocated to an auxiliary path is to be extended, the band manager 101 determines whether or not at least a part of the frequency band allocated to the auxiliary path after the extension overlaps a frequency band allocated to an active path or another auxiliary path. If the band manager 101 determines that at least the part of the frequency band allocated to the auxiliary path after the extension overlaps the frequency band allocated to the active path or the other auxiliary path, the band manager 101 changes the frequency band allocated to the auxiliary path and to be extended so that the frequency band allocated to the auxiliary path after the extension does not overlap frequency bands allocated to an active path or another auxiliary paths.

Specifically, as described with reference to FIG. 5, when a usable band allocated to an auxiliary path is to be extended, the band manager 101 determines whether or not the usable band allocated to the auxiliary path after the extension overlaps a usable band allocated to another active or auxiliary path. If the band manager 101 determines that the usable band allocated to the auxiliary path after the extension overlaps the usable band allocated to the other active or auxiliary path, the band manager 101 changes the usable band allocated to the auxiliary path and to be extended so that the usable band allocated to the auxiliary path after the extension does not overlap a usable band allocated to an active or another auxiliary path.

The band manager 101 executes the aforementioned process using the section table 131 stored in the HDD 13 and the band table 132 stored in the HDD 13. The managing server 1 determines, based on the network configuration information 130, the sections SC1 to SC8 in which the active and auxiliary paths that are to be processed are provided.

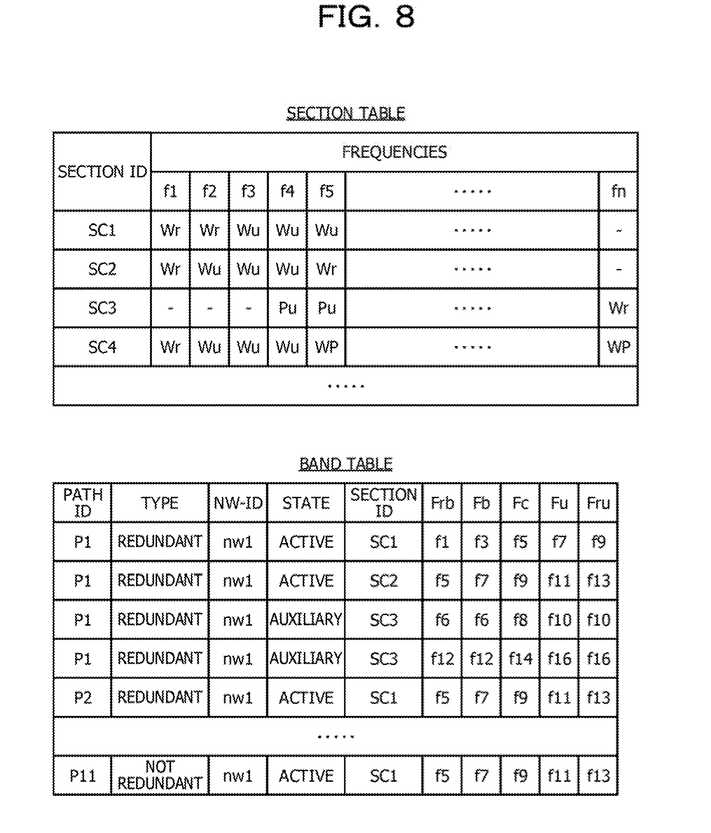

FIG. 8 illustrates an example of the section table 131 and the band table 132. The section table 131 indicates, for each of section IDs (SC1 to SC8) identifying the sections SC1 to SC8, allocation states of frequencies f1 to fn indicated by a symbol G in FIG. 2. The allocation states are indicated by symbols “Wr”, “Wu”, “Pu”, “WP”, and “−” as an example.

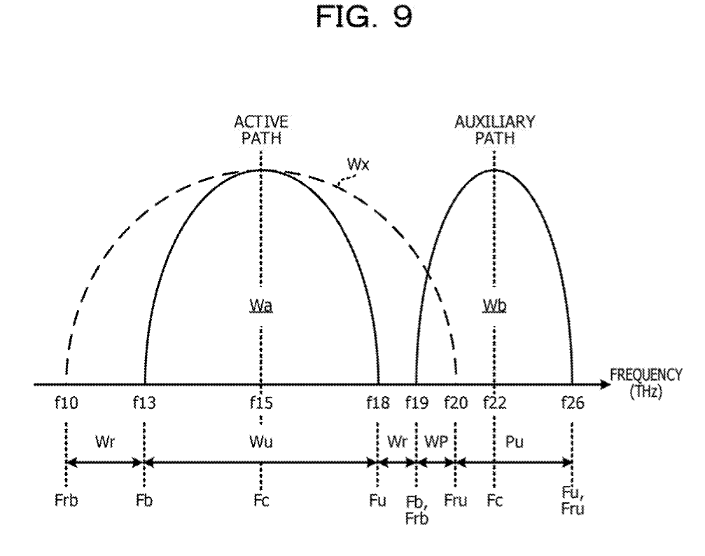

FIG. 9 describes definitions of symbols and parameters indicated in the section table 131 and the band table 132. In FIG. 9, a symbol Wa indicates the frequency spectrum of an optical signal within an active path; a symbol Wx indicates a frequency spectrum corresponding to a maximum extendable band for the optical signal within the active path; a symbol Wb indicates the frequency spectrum of an optical signal within an auxiliary path; and frequencies f10 to f26 indicate a frequency band indicated by the symbol G in FIG. 2.

As is understood from FIG. 9, a symbol “Wu” indicates a band usable for an active path; a symbol “Wr” indicates a band that is within a maximum extendable band for an active path and is not allocated to an auxiliary path; a symbol “WP” indicates a band that is within a maximum extendable band for an active path and already allocated to an auxiliary path or is usable for the auxiliary path and overlaps the maximum extendable band; a symbol “Pu” indicates a band that is usable for an auxiliary path and does not overlap a maximum extendable band for an active path or is already allocated to only the auxiliary path; and a symbol “−” is not illustrated and indicates an available band that is not allocated to any of the active and auxiliary paths and is not within maximum extendable bands.

Thus, in the section table 131, “Wr” is set for the frequencies f10 to f12; “Wu” is set for the frequencies f13 to f17; “Wr” is set for the frequency f18; “WP” is set for the frequency f19; and “Pu” is set for the frequencies f20 to f25.

Refer to FIG. 8 again. The band manager 101 references the section table 131 and searches usable bands to be allocated to the active and auxiliary paths, as described later. In order to change a usable band allocated to an auxiliary path, the band manager 101 references the section table 131 and searches a band to which the usable band is to be changed. In addition, in order to extend usable bands allocated to active and auxiliary paths, the band manager 101 references the section table 131 and confirms allocation states of the bands after the extension. When the band manager 101 allocates, extends, or deletes a band usable for an active or auxiliary path or changes a band usable for an auxiliary path, the band manager 101 updates the band table 132.

In the band table 132, path IDs, types, a network ID (NW-ID), states, section IDs, central frequencies Fc, minimum usable frequencies Fb, maximum usable frequencies Fu, lower limit frequencies Frb, and upper limit frequencies Fru are registered. The path IDs are identifiers identifying active and auxiliary paths. The types indicate whether or not each of the paths is made redundant. The network ID is an identifier of the network 5 in which the active and auxiliary paths identified by the path IDs are provided.

The states indicate whether each of the paths identified by the path IDs is an active path (refer to “active”) or an auxiliary path (refer to “auxiliary”). The section IDs are identifiers of the sections SC1 to SC8.

The central frequencies Fc, the minimum usable frequencies Fb, the maximum usable frequencies Fu, the lower limit frequencies Frb, and the upper limit frequencies Fru are illustrated in FIG. 9. The central frequencies Fc indicate the central frequencies of frequency spectra of optical signals within the active and auxiliary paths. In this example, the central frequency Fc of the optical signal within the active path is the frequency f15, while the central frequency Fc of the optical signal within the auxiliary path is the frequency f22.

The minimum usable frequencies Fb and the maximum usable frequencies Fu indicate lower and upper frequencies of usable bands. In this example, the minimum usable frequency Fb of the active path is the frequency f13, while the maximum usable frequency Fu of the active path is the frequency f18. The minimum usable frequency Fb of the auxiliary path is the frequency f19, while the maximum usable frequency Fu of the auxiliary path is the frequency f26.

The lower limit frequencies Frb and the upper limit frequencies Fru indicate lower limit frequencies and upper limit frequencies of the maximum extendable bands for the active paths. In this example, the lower limit frequency Frb of the optical signal within the active path is the frequency f10, while the upper limit frequency Fru of the optical signal within the active path is the frequency f20. The lower limit frequencies Frb and upper limit frequencies Fru of the auxiliary paths match the minimum usable frequencies Fb and maximum usable frequencies Fu of the auxiliary paths.

Refer to FIG. 7 again. When a frequency band for an active or auxiliary path is registered in the band table 132 or when a registered frequency band for an active or auxiliary path is changed, the band manager 101 notifies the section manager 102 and the device INF 104 of details of the registration or details of the change. The section manager 102 updates the section table 131 based on the notification. The device INF 104 transmits path setting information based on the notification to an appropriate ROADM device 2 via a communication port 14.

The control unit 29 of the ROADM device 2 sets a wavelength in the multiplexing and demultiplexing unit 20 based on the path setting information. The ROADM device 2 transmits the optical signals S1 to S3 in accordance with the allocation of frequency bands by the band manager 101.

Next, processes to be executed by the managing server 1 are described.

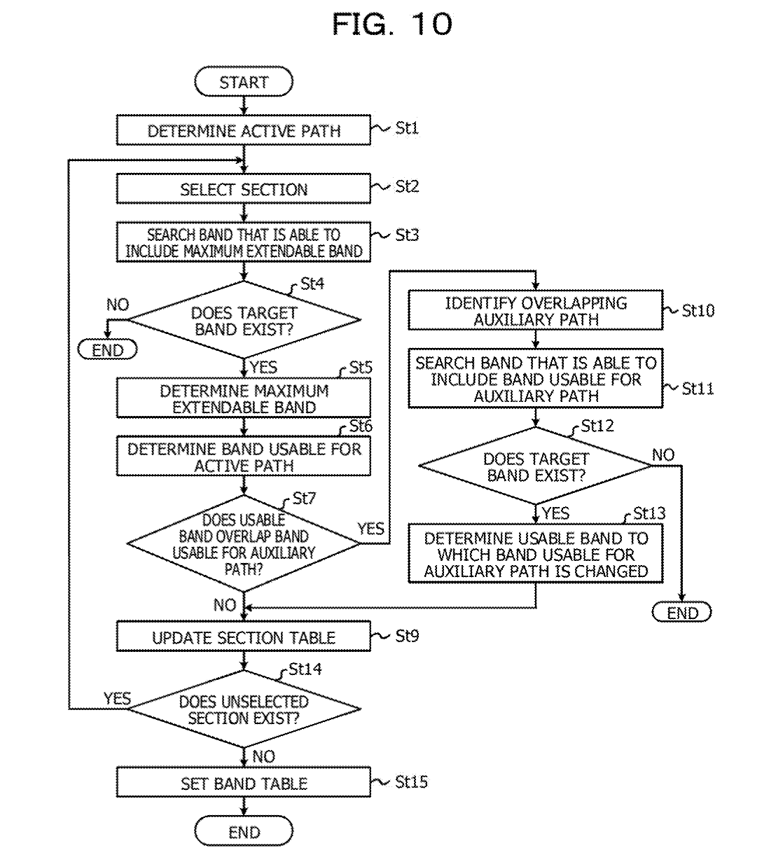

FIG. 10 is a flowchart of an example of a process of setting an active path. This process is executed when a request to set a path is provided to the managing server 1 based on an operation of the operation terminal 3 by the operator. A process of allocating a frequency band is automatically executed by the managing server 1 and does not depend on the operation by the operator.

First, the path determiner 100 determines an active path based on the network configuration information 130 (in St1). The path determiner 100 determines the paths P1 to P4 illustrated in FIG. 1 as an example.

Then, the band manager 101 selects one of the sections SC1 to SC8 for the determined active path (in St2). After St2, a process of setting the active path for the section selected from among the sections SC1 to SC8 is executed until another section is selected from among the sections SC1 to SC8.

Then, the band manager 101 references the section table 131 and searches a frequency band that is able to include a maximum extendable band for the active path (in St3). Specifically, the band manager 101 searches, for a section ID identifying the selected section and indicated in the section table 131, the frequency band that is within a frequency band indicated by symbols “−” or “Pu” and is wider than the maximum extendable band for the active path. Thus, the band manager 101 allocates a usable band to the active path so that maximum extendable bands for active paths do not overlap each other.

If the target frequency band does not exist as a result of the search (No in St4), the band manager 101 terminates the process. If the target frequency band exists as a result of the search (Yes in St4), the band manager 101 determines the maximum extendable band within the target frequency band (in St5) and determines a band usable for the active path (in St6). The maximum extendable band is determined based on the transmission rates, indicated in the network configuration information 130, of the TPs 23 to 25.

Then, the band manager 101 references the section table 131 and determines whether or not the band usable for the determined active path overlaps a band usable for an auxiliary path (in St7). Specifically, the band manager 101 determines, for the section ID identifying the selected section in the section table 131, whether or not at least a part of the band usable for the determined active path is set to “Pu”.

If the band usable for the active path does not overlap the band usable for the auxiliary path (No in St7), the section manager 102 updates the section table 131 based on the result of the allocation of the frequency band by the band manager 101 (in St9). Specifically, the section manager 102 changes, for the section ID identifying the selected section and indicated in the section table 131, a symbol “−” set for a frequency within the allocated usable band, to a symbol “Wu”. Then, the section manager 102 changes, to a symbol “Wr”, a symbol “−” set for a frequency within a frequency band that is within the maximum extendable band and excludes the usable bands.

Next, the band manager 101 determines whether or not an unselected section exists among the sections SC1 to SC8 for the active path to be set (in St14). If the unselected section does not exist (No in St14), the band manager 101 sets the determined usable band and the maximum extendable band in the band table 132 (in St15). Specifically, the band manager 101 registers the central frequency Fc, minimum usable frequency Fb, and maximum usable frequency Fu of the usable band and the lower limit frequency Fc and upper limit frequency of the maximum extendable band in the band table 132. If the unselected section exists (Yes in St14), the band manager 101 selects the unselected section from among the sections SC1 to SC8 in the process of St2.

If the band usable for the active path overlaps the band usable for the auxiliary path (Yes in St7), the band manager 101 references the band table 132 and identifies the auxiliary path (in St10). The band manager 101 changes the band usable for the identified auxiliary path by executing the following process.

Then, the band manager 101 references the section table 131 and searches a frequency band that is able to include the band usable for the target auxiliary path (in St11). Specifically, the band manager 101 searches, for the section ID identifying the selected section and indicated in the section table 131, the frequency band that is within a frequency band indicated by symbols “−” or “Wr” and is wider than the band usable for the auxiliary path.

If the target frequency band does not exist as a result of the search (No in St12), the band manager 101 terminates the process. On the other hand, if the target frequency band exists as a result of the search (Yes in St12), the band manager 101 determines, based on the target frequency band, a usable band to which the band usable for the auxiliary path is changed (in St13).

Then, the section manager 101 executes the aforementioned process of St9. In this case, the section manager 102 sets the band usable for the active path and the maximum extendable band for the active path and changes the setting of the band usable for the auxiliary path. Specifically, the section manager 102 changes, for the section ID identifying the selected section and indicated in the section table 131, symbols “−” and “Pu” set for frequencies within the usable band allocated to the active path, to symbols “Wu”. Then, the section manager 102 changes, to symbols “Wr”, symbols “−” and “Pu” set for frequencies within a frequency band that is within the extendable band and excludes the usable band. In addition, the section manager 102 changes, for the section ID identifying the selected section and indicated in the section table 131, symbols “−” and “Wr” set for frequencies within the usable band allocated to the auxiliary path after the change to symbols “Pu” and “WP”. After that, the band manager 101 executes the aforementioned process of St14.

Then, if the unselected section does not exist (No in St14), the band manager 101 sets the band table 132 (in St15). In this case, the band manager 101 sets the band usable for the active path and changes the setting of the band usable for the auxiliary path. Specifically, the band manager 101 registers, in the band table 132, the central frequency Fc, minimum usable frequency Fb, maximum usable frequency Fu, lower limit frequency Frb(=Fb), and upper limit frequency Fru(=Fu) of the usable band. In this manner, the process of setting an active path is executed.

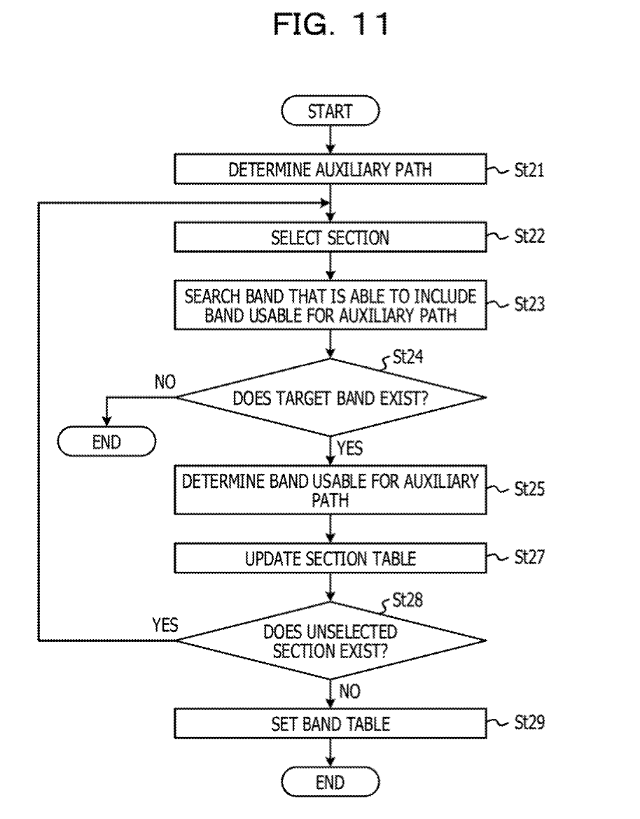

FIG. 11 is a flowchart of an example of a process of setting an auxiliary path. This process is executed after the execution of the aforementioned process of setting an active path, for example.

First, the path determiner 100 determines an auxiliary path based on the network configuration information 130 (in St21). As an example, the path determiner 100 determines the paths P1 to P4 illustrated in FIG. 1.

Next, the band manager 101 selects one of the sections SC1 to SC8 for the determined auxiliary path (in St22). After St22, until another section is selected from among the sections SC1 to SC8, a process of setting the auxiliary path for the section selected from among the sections SC1 to SC8 is executed.

Then, the band manager 101 references the section table 131 and searches a band that is able to include a band usable for the auxiliary path (in St23). Specifically, the band manager 101 searches, for a section ID identifying the selected section and indicated in the section table 131, the frequency band that is within a frequency band indicated by symbols “−” or “Wr” and is wider than the usable band. Thus, the band manager 101 allocates, to the auxiliary path, the unallocated band within the maximum extendable band for the active path.

If the target frequency band does not exist as a result of the search (No in St24), the band manager 101 terminates the process. If the target frequency band exists as a result of the search (Yes in St24), the band manager 101 determines the band usable for the auxiliary path (in St25).

Then, the section manager 102 updates the section table 131 based on the result of the allocation of the frequency band by the band manager 101 (in St27). Specifically, the section manager 102 changes, for the section ID identifying the selected section and indicated in the section table 131, symbols “−” and “Wr” set for frequencies within the allocated usable band, to symbols “Pu” and “WP”.

Then, the band manager 101 determines whether or not an unselected section exists among the sections SC1 to SC8 for the auxiliary path to be set (in St28). If the unselected section does not exist (No in St28), the band manager 101 sets the determined usable band in the band table 132 (in St29). Specifically, the band manager 101 registers, in the band table 132, the central frequency Fc, minimum usable frequency Fb, maximum usable frequency Fu, lower limit frequency Frb(=Fb), and upper limit frequency Fru(=Fu) of the usable band.

If the unselected section exists (Yes in St28), the band manager 101 selects the unselected section from among the sections SC1 to SC8 in the process of St22. In this manner, the process of setting an auxiliary path is executed.

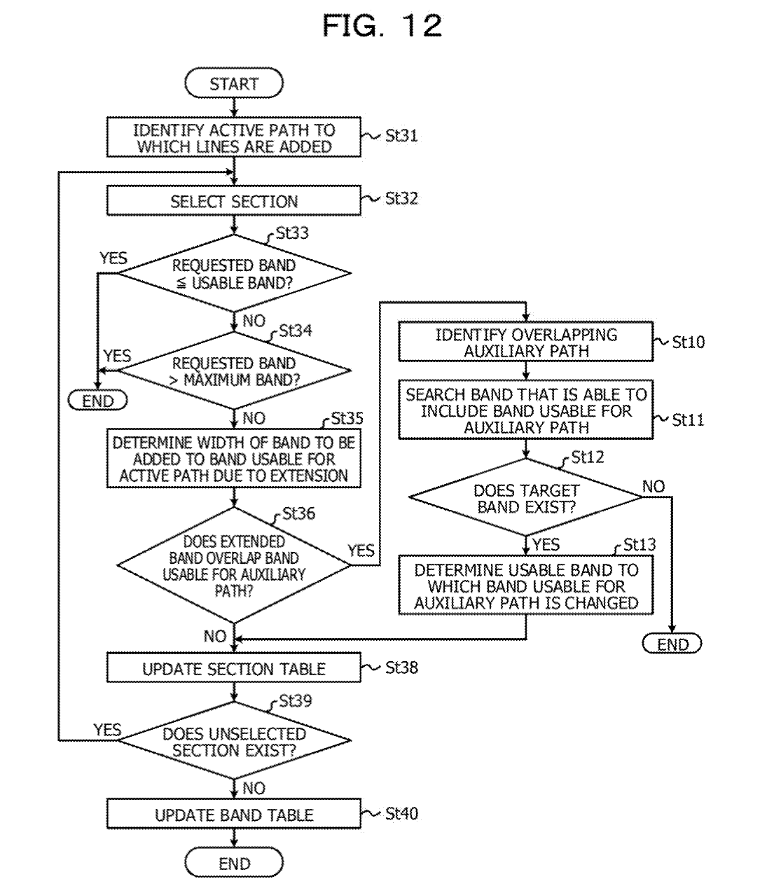

FIG. 12 is a flowchart of an example of a process of extending a band usable for an active path. This process is executed when a request to add communication lines L1 to Lm to an active path is provided to the managing server 1 based on an operation of the operation terminal 3 by the operator. Since the managing server 1 automatically determines a band to be added to the usable band due to the extension of the usable band, the determination does not depends on the operation by the operator. Processes that are illustrated in FIG. 12 and common to those illustrated in FIG. 10 are indicated by the same reference symbols as those illustrated in FIG. 10, and a description thereof is omitted.

The band manager 101 identifies, from information received from the operation terminal 3, an active path to which communication lines L1 to Lm are added (in St31). Then, the band manager 101 selects one of the sections SC1 to SC8 for the identified active path (in St32). After St32, until another section is selected from among the sections SC1 to SC8, a process of extending the band usable for the active path for the section selected from among the sections SC1 to SC8 is executed.

Then, the band manager 101 compares, based on information received from the operation terminal 3, the band usable for the active path with a frequency band (hereinafter referred to as “requested band”) requested for the communication lines L1 to Lm to be contained (in St33). If the requested band is equal to or lower than the band usable for the active path (Yes in St33), the band manager 101 does not extend the usable band and terminates the process.

If the requested band is higher than the band usable for the active path (No in St33), the band manager 101 compares the requested band with a maximum band for the transmission path (optical fiber 9) (in St34). If the requested band is higher than the maximum band for the transmission path (Yes in St34), the band manager 101 does not extend the usable band and terminates the process.

If the requested band is equal to or lower than the maximum band for the transmission path (No in St34), the band manager 101 determines the width of a band to be added to the band usable for the active path due to the extension based on the requested band (in St35). Then, the band manager 101 references the section table 131 and determines whether or not the extended frequency band overlaps a band usable for an auxiliary path (in St36). Specifically, the band manager 101 determines, for the section ID identifying the selected section and indicated in the section table 131, whether or not a frequency band indicated by symbols “WP” set for frequencies within the extended frequency band exists.

If the extended frequency band does not overlap the band usable for the auxiliary path (No in St36), the section manager 102 updates the section table 131 based on the band usable for the active path and extended by the band manager 101 (in St38). Specifically, the section manager 102 changes, for the section ID identifying the selected section and indicated in the section table 131, symbols “Wr” set for frequencies within the extended usable frequency band within the maximum extendable band for the target active path, to symbols “Wu”.

Then, the band manager 101 determines whether or not an unselected section exists among the sections SC1 to SC8 for the active path to be set (in St39). If the unselected section does not exist (No in St39), the band manager 101 updates the setting of the band usable for the active path in the band table 132 (in St40). Specifically, the band manager 101 updates the minimum usable frequency Fb and maximum usable frequency Fu of the band usable for the active path.

If the unselected section exists (Yes in St39), the band manager 101 selects the unselected section from among the sections SC1 to SC8 in the process of St32.

If the extended frequency band overlaps the band usable for the auxiliary path (Yes in St36), the band manager 101 executes the aforementioned processes of St10 to St13. If the extended band usable for the active path overlaps a usable band allocated to an auxiliary path, the band manager 101 changes the band usable for the auxiliary path so that the band usable for the auxiliary path does not overlap the extended band usable for the active path.

Then, the section manager 102 updates the section table 131 based on the band usable for the active path and extended by the band manager 101 and the band usable for the auxiliary path and changed by the band manager 101 (in St38). Specifically, the section manager 102 changes, for the section ID identifying the selected section and indicated in the section table 131, symbols “−” and “Wr” set for frequencies within the changed band usable for the auxiliary path, to symbols “Pu” and “WP”.

The section manager 102 changes, for the section ID identifying the selected section and indicated in the section table 131, symbols “Pu” and “WP” set for frequencies within the band usable for the auxiliary path before the change to symbols “−” and “Wr”. In addition, the section manager 102 changes, for the section ID identifying the selected section and indicated in the section table 131, symbols set for the extended usable band within the maximum extendable band for the target active path, to symbols “Wu”. After that, the aforementioned process of St39 is executed.

If the unselected section does not exist (No in St39), the band manager 101 updates the band table 131 based on the extended band usable for the active path and the changed band usable for the auxiliary path (in St40). Specifically, the band manager 101 changes the minimum usable frequency Fb and maximum usable frequency Fu of the band usable for the active path and the central frequency Fc, minimum usable frequency Fb, maximum usable frequency Fu, lower limit frequency Frb(=Fb), and upper limit frequency Fru(=Fu) of the band usable for the auxiliary path. In this manner, the process of extending a band usable for an active path is executed.

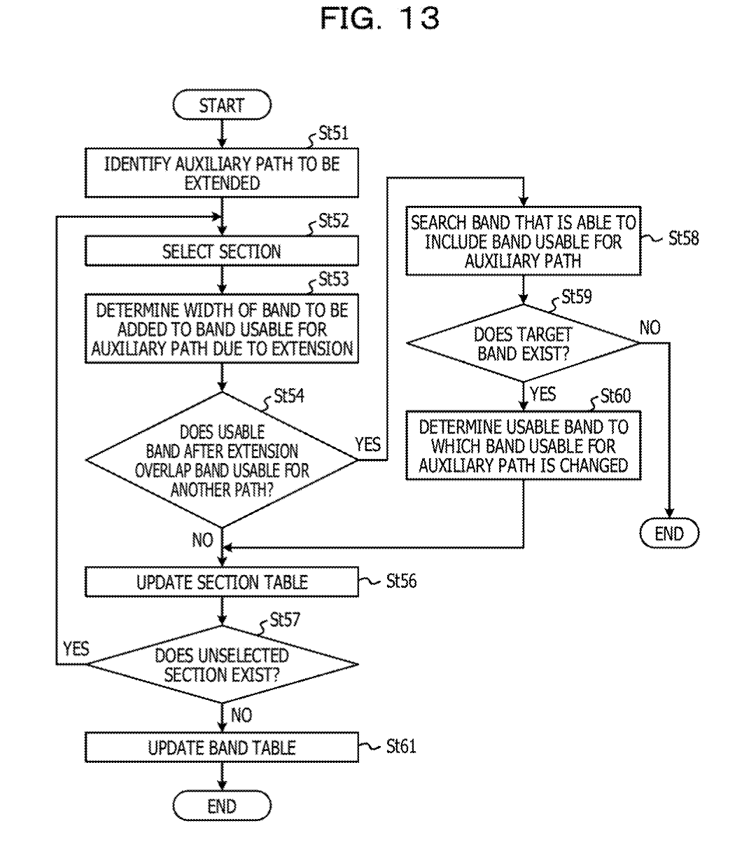

FIG. 13 is a flowchart of an example of a process of extending a band usable for an auxiliary path. This process is executed after the process of extending a band usable for an active path, for example. The width of a band to be added to the band usable for the auxiliary path due to the extension is equal to the width of the band added to the band usable for the active path due to the extension.

The band manager 101 identifies an auxiliary path for which a usable band is to be extended (in St51). Then, the band manager 101 selects one of the sections SC1 to SC8 for the identified auxiliary path (in St52). After St52, until another section is selected from among the sections SC1 to SC8, a process of extending the band usable for the auxiliary path for the section selected from among the sections SC1 to SC8 is executed.

Then, the band manager 101 determines the width of a band to be added to the band usable for the auxiliary path due to the extension of the usable band (in St53). The band manager 101 references the section table 131 and determines whether or not the extended frequency band overlaps at least any of usable bands allocated to other paths (active and auxiliary paths) (in St54).

Specifically, the band manager 101 determines, for a section ID identifying the selected section and indicated in the section table 131, whether or not a frequency band indicated by a symbol “Pu”, “Wu”, or “WP” set for a frequency within the extended frequency band exists. When the usable band allocated to the auxiliary path is to be extended, the band manager 101 determines whether or not the usable band after the extension overlaps a usable band allocated to another active or auxiliary path.

If the extended frequency band does not overlap at least any of the usable bands allocated to the other paths (No in St54), the section manager 102 updates the section table 131 based on the band usable for the auxiliary path and extended by the band manager 101 (in St56). Specifically, the section manager 102 changes, for the section ID identifying the selected section and indicated in the section table 131, symbols “−” and “Wr” set for frequencies within the band usable for the auxiliary path after the extension, to symbols “Pu” and “WP”.

Then, the band manager 101 determines whether or not an unselected section exists among the sections SC1 to SC8 for the auxiliary path for which the usable band is to be extended (in St57). If the unselected section does not exist (No in St57), the band manager 101 updates the setting of the band usable for the auxiliary path in the band table 132 (in St61). Specifically, the band manager 101 changes the minimum usable frequency Fb, maximum usable frequency Fu, lower limit frequency Frb(=Fb), and upper limit frequency Fru(=Fu) of the band usable for the auxiliary path.

If the unselected section exists (Yes in St57), the band manager 101 selects the unselected section from among the sections SC1 to SC8 in the process of St52.

If the extended frequency band overlaps at least any of the usable bands allocated to the other paths (Yes in St54), the band manager 101 searches a frequency band that is able to include the band usable for the auxiliary path and to be extended (in St58). Specifically, the band manager 101 searches, for the section ID identifying the selected section and indicated in the section table 131, the frequency band that is wider than the band usable for the auxiliary path and is within a frequency band indicated by a symbol “−” or “Wr”.

If the target frequency band does not exist as a result of the search (No in St59), the band manager 101 terminates the process. If the target frequency band exists as a result of the search (Yes in St59), the band manager 101 determines the band usable for the auxiliary path and to be changed, based on the target frequency band (in St60).

If the band manager 101 determines that the band usable for the auxiliary path after the extension overlaps the usable band allocated to the other active or auxiliary path, the band manager 101 changes the band usable for the auxiliary path and to be extended so that the band usable for the auxiliary path after the extension does not overlap usable bands allocated to other paths.

Then, the section manager 102 updates the section table 131 based on the band usable for the auxiliary path and changed by the band manager 101 (in St56). Specifically, the section manager 102 changes, for the section ID identifying the selected section and indicated in the section table 131, symbols “−” and “Wr” set for the band usable for the auxiliary path after the change to symbols “Pu” and “WP”.

The section manager 102 changes, for the section ID identifying the selected section and indicated in the section table 131, symbols “Pu” and “WP” set for frequencies within the band usable for the auxiliary path before the change to symbols “−” and “Wr”. After that, the aforementioned process of St57 is executed.

If the unselected section does not exist (No in St57), the band manager 101 updates the band table 132 based on the changed band usable for the auxiliary path (in St61). Specifically, the band manager 101 changes the central frequency Fc, minimum usable frequency Fb, maximum usable frequency Fu, lower limit frequency Frb(=Fb), and upper limit frequency Fru(=Fu) of the band usable for the auxiliary path. In this manner, the process of extending a band usable for an auxiliary path is executed.

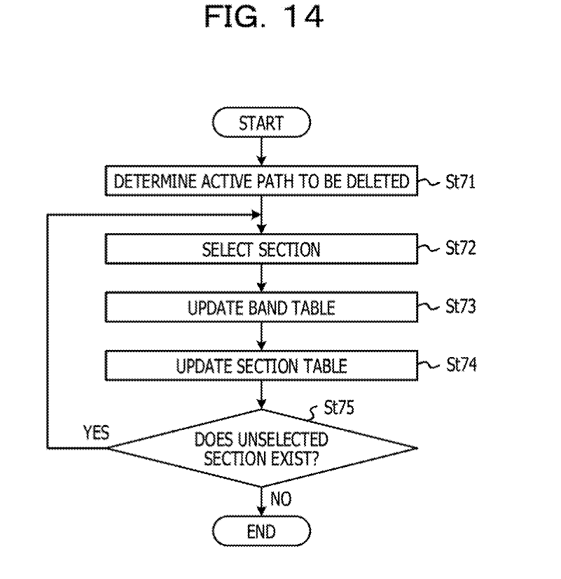

FIG. 14 is a flowchart of an example of a process of deleting an active path. This process is executed when a request to delete a path is provided to the managing server 1 by an operation of the operation terminal 3 by the operator. Since a frequency band allocated to the active path to be deleted is automatically released, the frequency band does not depend on the operation by the operator.

The band manager 101 determines an active path to be deleted, based on the network configuration information 130 (in St71). Then, the band manager 101 selects one of sections SC1 to SC8 for the determined active path (in St72). After St72, until another section is selected from among the sections SC1 to SC8, a process of deleting the active path is executed for the section selected from among the sections SC1 to SC8.

Then, the band manager 101 updates the band table 132 by deleting, from the band table 132, information on the active path to be deleted (in St73). The section manager 102 updates the section table 131 based on the usable band allocated to the deleted active path and the maximum extendable band for the deleted active path (in St74). Specifically, the section manager 102 changes, for the section ID identifying the selected section and indicated in the section table 131, symbols “Wu” and “Wr” set for frequencies within the maximum extendable band for the active path, to symbols “−” and changes, for the section ID identifying the selected section and indicated in the section table 131, a symbol “WP” set for a frequency within the maximum extendable band for the active path, to a symbol “Pu”.

Then, the band manager 101 determines whether or not an unselected section exists among the sections SC1 to SC8 for the active path to be deleted (in St75). If the unselected section does not exist (No in St75), the band manager 101 terminates the process. If the unselected section exists (Yes in St75), the band manager 101 selects the unselected section from among the sections SC1 to SC8 in the process of St72. In this manner, the process of deleting an active path is executed.

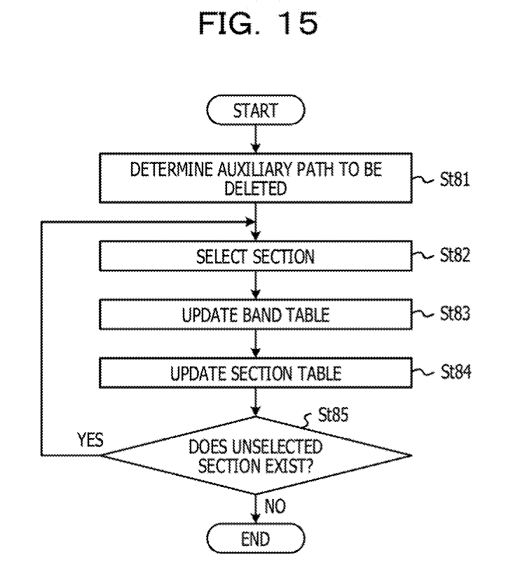

FIG. 15 is a flowchart of an example of a process of deleting an auxiliary path. This process is executed when an active path is deleted. Since a frequency band allocated to the auxiliary path to be deleted is automatically released, the frequency band does not depend on an operation by the operator.

The band manager 101 determines an auxiliary path to be deleted, based on the network configuration information 130 (in St81). Then, the band manager 101 selects one of the sections SC1 to SC8 for the determined auxiliary path (in St82). After St82, until another section is selected from among the sections SC1 to SC8, a process of deleting the auxiliary path is executed for the section selected from among the sections SC1 to SC8.

Then, the band manager 101 updates the band table 132 by deleting information on the auxiliary path to be deleted (in St83). Then, the section manager 102 updates the section table 131 based on a usable band allocated to the deleted auxiliary path (in St84). Specifically, the section manager 102 changes, for a section ID identifying the selected section and indicated in the section table 131, symbols “Pu” and “WP” set for frequencies within the band usable for the auxiliary path, to symbols “−” and “Wr”.

Then, the band manager 101 determines whether or not an unselected section exists among the sections SC1 to SC8 for the auxiliary path to be deleted (in St85). If the unselected section does not exist (No in St85), the band manager 101 terminates the process. If the unselected section exists (Yes in St85), the band manager 101 selects the unselected section from among the sections SC1 to SC8 in the process of St82. In this manner, the process of deleting an auxiliary path is executed.

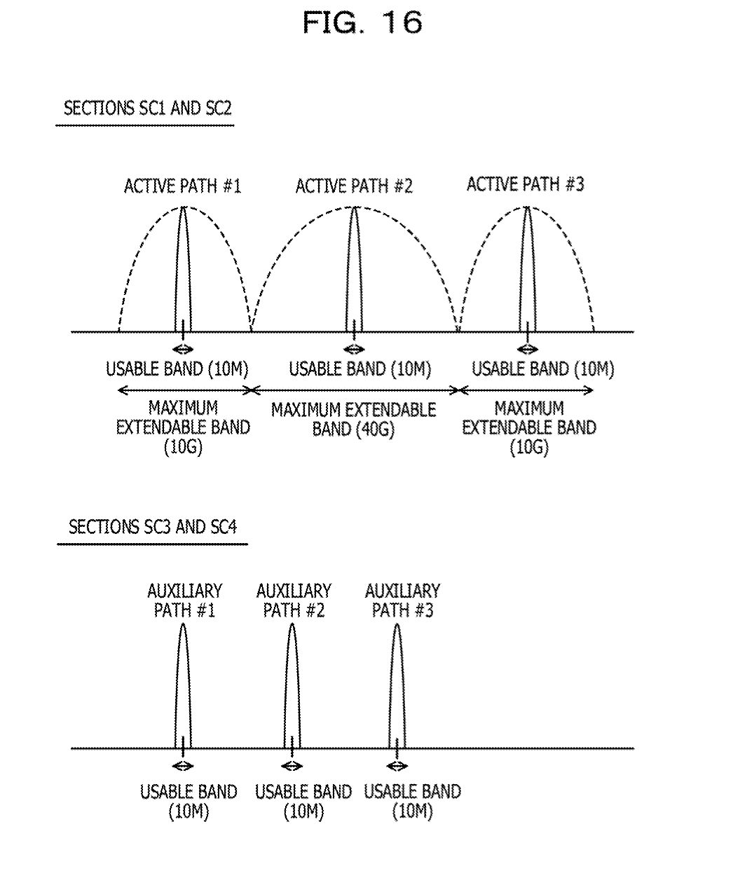

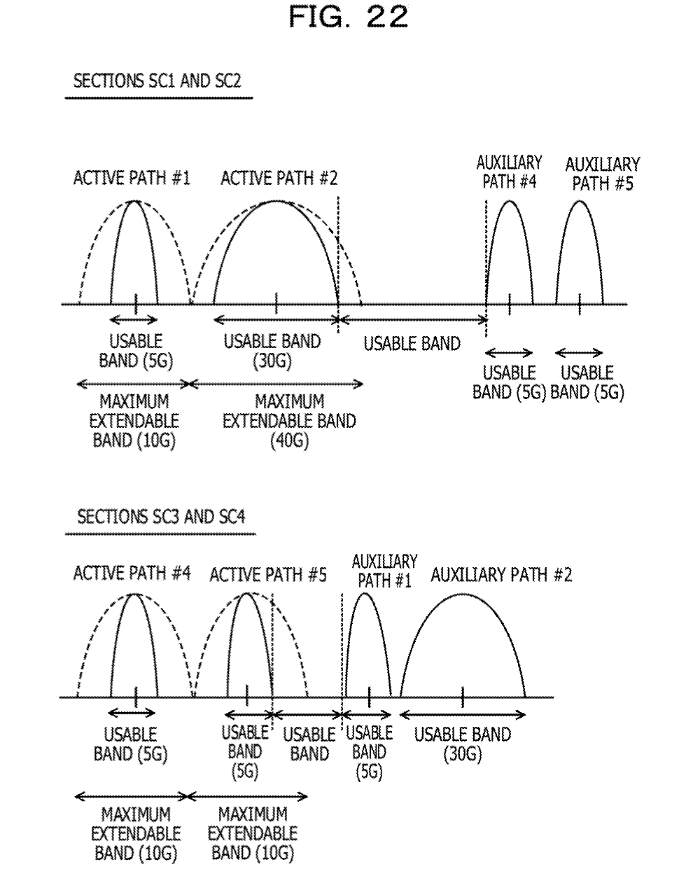

Next, an example of operations of the managing server 1 for managing frequency bands allocated to active and auxiliary paths is described. FIGS. 16 and 22 chronologically illustrate the example of the operations of the managing server 1 for managing the frequency bands allocated to the active and auxiliary paths. Specifically, FIGS. 16 to 22 illustrate frequency spectra of optical signals within the active and auxiliary paths. Although the example describes a case where the paths are provided in the network 5 illustrated in FIG. 1, but the operations are not limited to this. The operations of managing the frequency bands may be executed in a network configured in another form.

The managing server 1 determines active paths #1 to #3 and auxiliary paths #1 to #3 as paths extending from the node N1 as start points of the active and auxiliary paths #1 to #3 to the node N3 as end points of the active and auxiliary paths #1 to #3. The active paths #1 to #3 extend through the ROADM devices 2 of the nodes N1, N2, and N3 in this order. The auxiliary paths #1 to #3 extend through the ROADM devices 2 of the nodes N1, N5, and N3 in this order. In other words, the active paths #1 to #3 extend through the sections SC1 and SC2, and the auxiliary paths #1 to #3 extend through the sections SC3 and SC4.

The auxiliary paths #1 to #3 are provided for the active paths #1 to #3. Thus, if a failure occurs in the active path #1, the path switching is executed and an optical signal is transmitted in the auxiliary path #1, instead of the active path #1, for example.

As illustrated in FIG. 16, the managing server 1 sets each of the active paths #1 to #3 to the sections SC1 and SC2 and sets each of the auxiliary paths #1 to #3 to the sections SC3 and SC4. Optical signals of the active paths #1 and #3 are transmitted and received by the TPs 23 and 25 having the transmission rates of 10 Gbps and included in the ROADM devices 2 of the nodes N1 and N3, while an optical signal of the active path #2 is transmitted and received by the TPs 24 having the transmission rates of 40 Gbps and included in the ROADM devices 2 of the nodes N1 and N3.

Thus, the managing server 1 ensures the maximum extendable bands for 10 Gbps for the active paths #1 and #3 and ensures the maximum extendable band for 40 Gbps for the active path #2. Frequency spectra of the maximum extendable bands are indicated by dotted lines.

The managing server 1 allocates usable bands for 10 Gbps to the active paths #1 to #3 so that the maximum extendable bands for the active paths #1 to #3 do not overlap each other in the sections SC1 and SC2. In this case, the maximum extendable bands for the active paths #1 to #3 are adjacent to each other. The transmission bands for 10 Gbps are used for optical signals for monitoring control, for example.

The managing server 1 allocates, to the auxiliary paths #1 to #3, usable bands for 10 Gbps, while the bands usable for the active paths #1 to #3 are for 10 Gbps. Maximum extendable bands for the auxiliary paths #1 to #3 are not ensured.

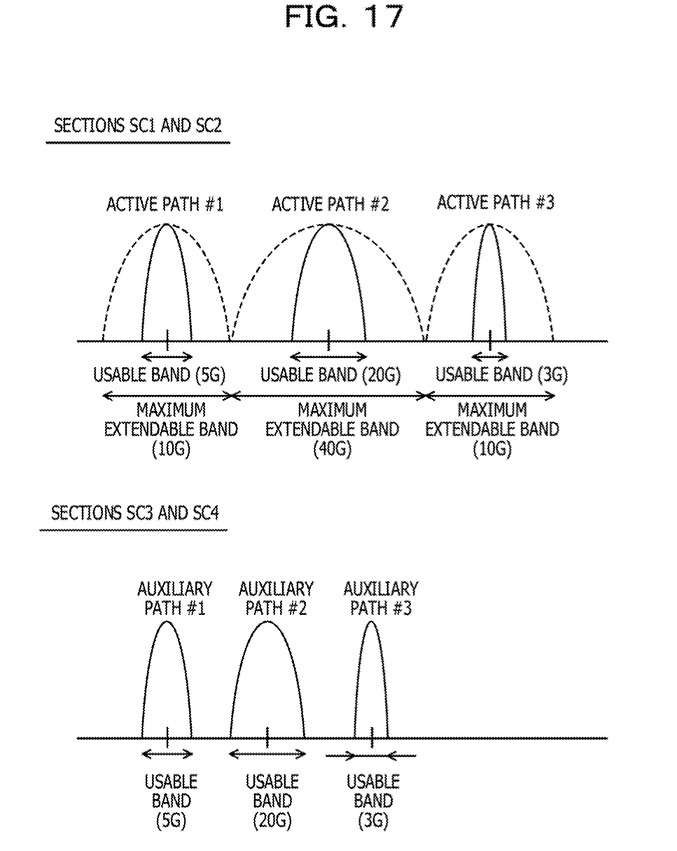

Then, the managing server 1 extends the bands usable for the active paths #1 to #3 and the bands usable for the auxiliary paths #1 to #3, as illustrated in FIG. 17. Each of the band usable for the active path #1 and the band usable for the auxiliary path #1 is extended to a frequency band for 5 Gbps. In this case, five communication lines L1 to Lm for approximately 1 Gbps are contained in each of the active path #1 and the auxiliary path #1, for example. Each of the band usable for the active path #2 and the band usable for the auxiliary path #2 is extended to a frequency band for 20 Gbps. Each of the band usable for the active path #3 and the band usable for the auxiliary path #3 is extended to a frequency band for 3 Gbps.

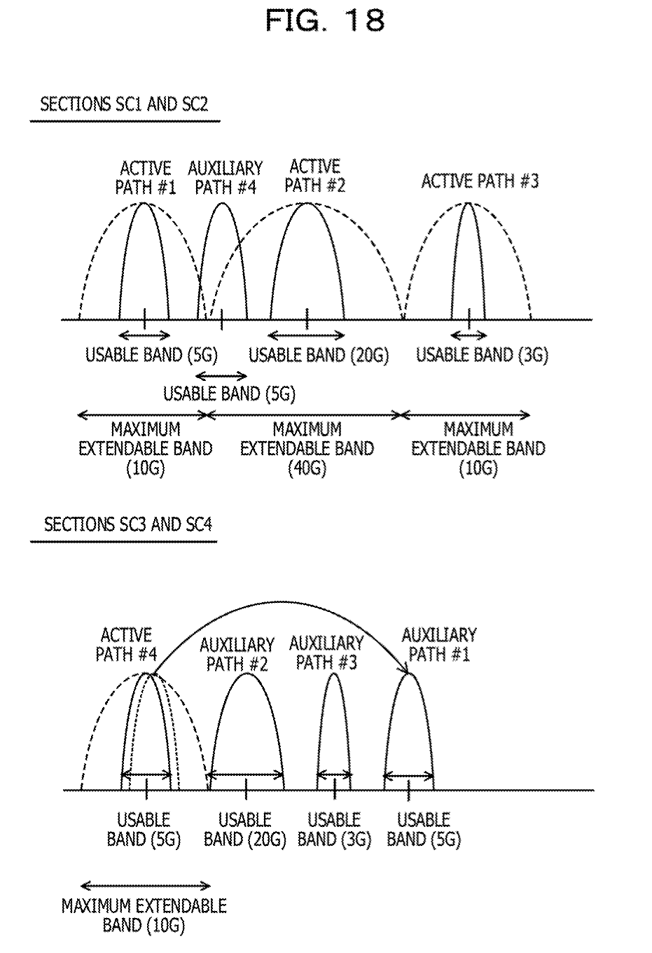

The managing server 1 sets, to the sections SC3 and SC4, a new active path #4 extending in the same route as the auxiliary paths #1 to #3, as indicated in FIG. 18. Then, the managing server 1 sets, to the sections SC1 and SC2, a new auxiliary path #4 extending in the same route as the active paths #1 to #3. The auxiliary path #4 is provided for the active path #4. A band usable for the active path #4 and a band usable for the auxiliary path #4 are frequency bands for 5 Gbps. An optical signal of the active path #4 is transmitted and received by other TPs included in the ROADM devices 2 and having a transmission rate of 10 Gbps. Thus, the maximum extendable band for the active path #4 is a frequency band for 10 Gbps.

First, the managing server 1 searches, for the sections SC3 and SC4, a frequency band that is able to include the band usable for the active path #4 from the low frequency side. As frequency bands that include the band usable for the active path #4, an available band (indicated by a symbol “−”) and bands (indicated by symbols “Pu”) usable for the auxiliary paths #1 to #3 exist. Thus, the managing server 1 allocates a usable band to the active path #4 so that the usable band allocated to the active path #4 overlaps the band usable for the auxiliary path #1 on the low frequency side.

Then, the managing server 1 changes the band usable for the auxiliary path #4 so that the band usable for the auxiliary path #4 does not overlap the band usable for the active path #4, as indicated by an arrow. As bands to which the band usable for the auxiliary path #4 may be changed, an available band (indicated by a symbol “−”) and an unallocated band (indicated by a symbol “Wr”) within the maximum extendable band exist. Thus, the managing server 1 changes the band usable for the auxiliary path #4 to the available band on the high frequency side of the auxiliary path #3.

Then, the managing server 1 searches, for the sections SC1 and SC2, a frequency band that is able to include the band usable for the auxiliary path #4 from the low frequency side. As frequency bands that include the band usable for the auxiliary path #4, an available band (indicated by a symbol “−”) and an unallocated band (indicated by symbol “Wr”) within the maximum extendable band exist.

Thus, the managing server 1 allocates, to the auxiliary path #4, the unallocated band within the maximum extendable bands for the active paths #1 and #2 for the sections SC1 and SC2. Specifically, the unallocated band between the bands usable for the active paths #1 and #2 is allocated to the auxiliary path #4.

The unallocated band is reserved for the active paths #1 and #2. Thus, even if an optical signal is transmitted in the auxiliary path #4 due to the path switching upon the occurrence of a failure, the band usable for the auxiliary path #4 does not overlap the bands usable for the active paths #1 to #3, error does not occur in the optical signal, and the communication service is not affected.

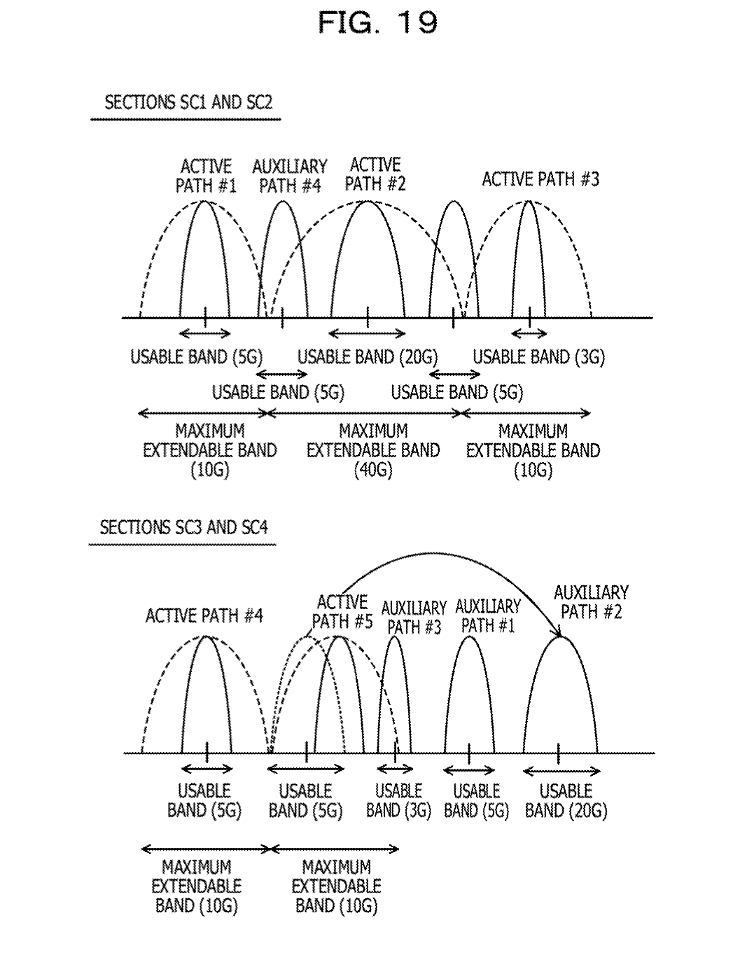

Next, the managing server 1 sets, to the sections SC3 and SC4, a new active path #5 extending in the same route as the auxiliary paths #1 to #3, as indicated in FIG. 19. Then, the managing server 1 sets, to the sections SC1 and SC2, a new auxiliary path #5 extending in the same route as the active paths #1 to #3. The auxiliary path #5 is provided for the active path #5. The band usable for the active path #5 and the band usable for the auxiliary path #5 are frequency bands for 5 Gbps. An optical signal of the active path #5 is transmitted and received by other TPs included in the ROADM devices 2 and having a transmission rate of 10 Gbps. Thus, the maximum extendable band for the active path #5 is a frequency band for 10 Gbps.

The managing server 1 searches, for the sections SC1 and SC2, a frequency band that is able to include the band usable for the auxiliary path #5 from the low frequency side. As frequency bands that include the band usable for the auxiliary path #5, an available band (indicated by a symbol “−”) and an unallocated band (indicated by a symbol “Wr”) within the maximum extendable band exist.

Thus, the managing server 1 allocates the unallocated band within the maximum extendable bands for the active paths #2 and #3 to the auxiliary path #5. Specifically, the managing server 1 allocates the unallocated band between the bands usable for the active paths #2 and #3 to the auxiliary path #5.

The unallocated band is reserved for the active paths #2 and #3. Thus, even if an optical signal is transmitted in the auxiliary path #5 due to the path switching upon the occurrence of a failure, the band usable for the auxiliary path #5 does not overlap the bands usable for the active paths #1 to #3, an error does not occur in the optical signal, and the communication service is not affected.

The managing server 1 searches, for the sections SC3 and SC4, a frequency band that is able to include the band usable for the active path #5 from the low frequency side. As frequency bands that include the band usable for the active path #5, an available band (indicated by a symbol “−”) and bands (indicated by symbols “Pu”) usable for the auxiliary paths #1 to #3 exist. Thus, the managing server 1 allocates a usable band to the active path #5 so that the usable band allocated to the active path #5 overlaps the band usable for the auxiliary path #2 on the low frequency side.

The managing server 1 allocates the usable band to the active path #5 so that the maximum extendable bands for the active paths #4 and #5 do not overlap each other. Thus, even if the bands usable for the active paths #4 and #5 are extended to the maximum extendable bands for the active paths #4 and #5, an error does not occur in optical signals within the active paths #4 and #5. In addition, since the managing server 1 allocates the usable band to the active path #5 so that the maximum extendable bands for the active paths #4 and #5 are adjacent to each other, the efficiency of using the frequency bands is improved.

Then, the managing server 1 changes the band usable for the auxiliary path #2 so that the band usable for the auxiliary path #2 does not overlap the band usable for the active path #5, as indicated by an arrow. As bands to which the band usable for the auxiliary path #2 may be changed, an available band (indicated by a symbol “-”) and an unallocated band (indicated by a symbol “Wr”) within the maximum extendable band exist. Thus, the managing server 1 changes the band usable for the auxiliary path #2 to the available band on the high frequency side of the auxiliary path #1.

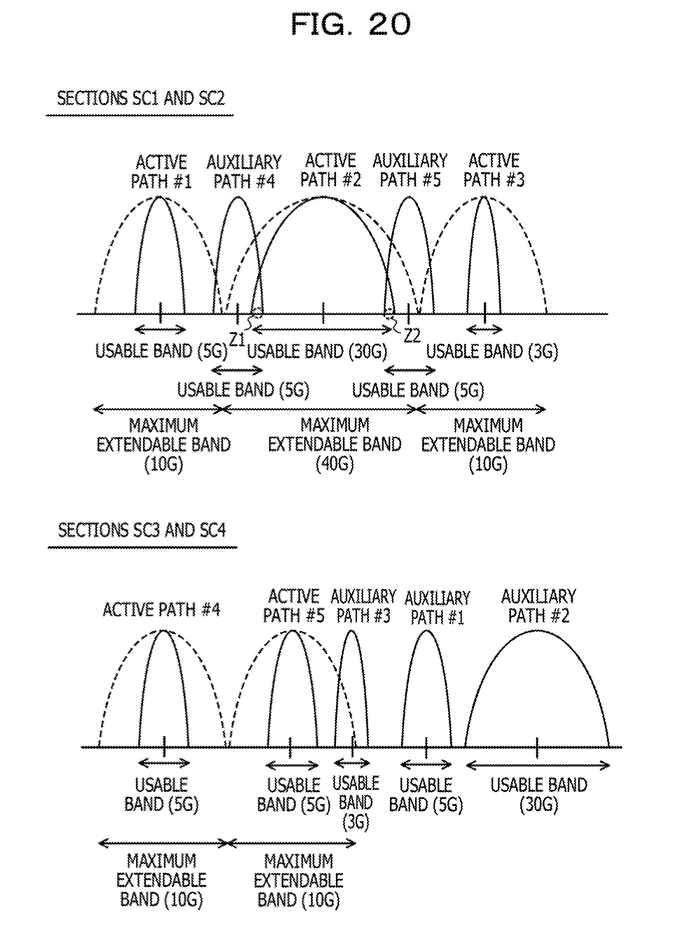

Next, the managing server 1 extends the band usable for the active path #2 for the sections SC1 and SC2, as illustrated in FIG. 20. For example, if communication lines L1 to Lm of 10 Gbps are newly contained in the active path #2, the band usable for the active path #2 is extended to a frequency band for 30 Gbps. In this case, parts of the extended band usable for the active path #2 overlap the bands usable for the auxiliary paths #4 and #5, as indicated by symbols Z1 and Z2.

The managing server 1 extends, for the sections SC3 and SC4, the band usable for the auxiliary path #2 provided for the active path #2 to a frequency band for 30 Gbps. In this case, the extended band usable for the auxiliary path #2 does not overlap the bands usable for the active paths #4 and #5 and the bands usable for the auxiliary paths #1 and #3. If the extended band usable for the auxiliary path #2 overlaps at least any of the bands usable for the active paths #4 and #5 and the bands usable for the auxiliary paths #1 and #3, the managing server 1 changes the band usable for the auxiliary path #2 and to be extended to another available band or unallocated band.

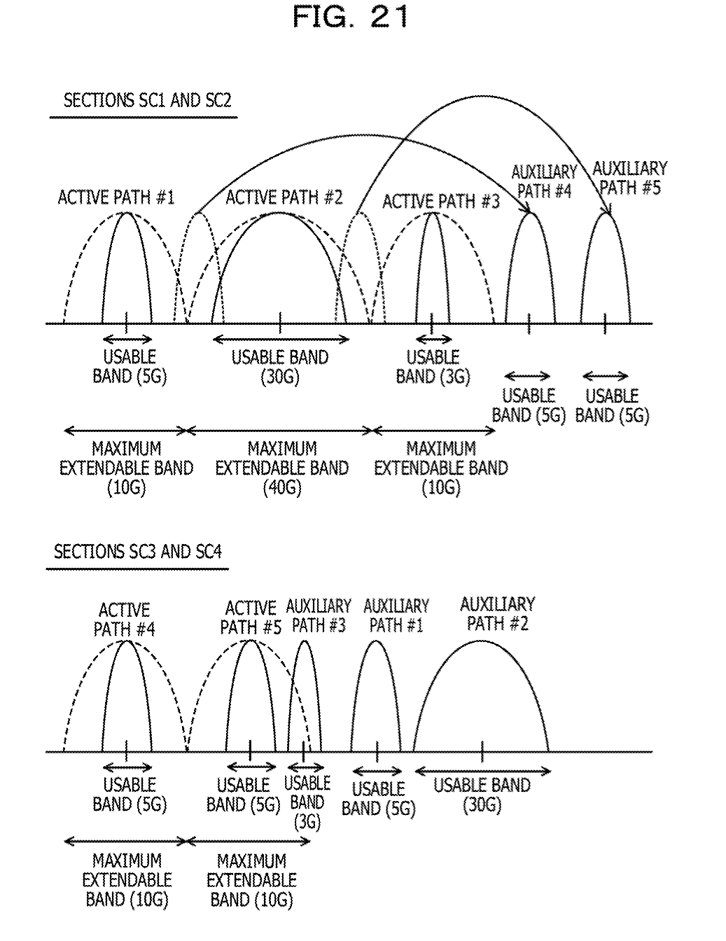

Next, the managing server 1 changes the bands usable for the auxiliary paths #4 and #5 for the sections SC1 and SC2 so that the bands usable for the auxiliary paths #4 and #5 do not overlap the extended band usable for the active path #2, as illustrated in FIG. 21. As bands to which the bands usable for the auxiliary paths #4 and #5 may be changed, available bands (indicated by symbols “−”) and unallocated bands (indicated by symbols “Wr”) within the maximum extendable bands exist. Thus, the managing server 1 changes the bands usable for the auxiliary paths #4 and #5 to the available bands on the high frequency side of the active path #3.

An optical signal is not transmitted in the auxiliary paths #4 and #5 unless the path switching is executed. Thus, if the path switching is not executed, the managing server 1 may extend the band usable for the active path #2 by changing the bands usable for the auxiliary paths #4 and #5 without affecting the communication service. Since the bands usable for the auxiliary paths #4 and #5 are changed so as not to overlap the extended band usable for the active path #2, the managing server 1 may prepare for the transmission of optical signals in the auxiliary paths #4 and #5 upon the path switching.

Next, the managing server 1 deletes the active path #3 set to the sections SC1 and SC2 and deletes the auxiliary path #3 set to the sections SC3 and SC4, as illustrated in FIG. 22. By the deletion, the usable band allocated to the active path #3 and the usable band allocated to the auxiliary path #3 are released as new usable bands.

According to the embodiment, the efficiency of using frequency bands may be improved, as described below.

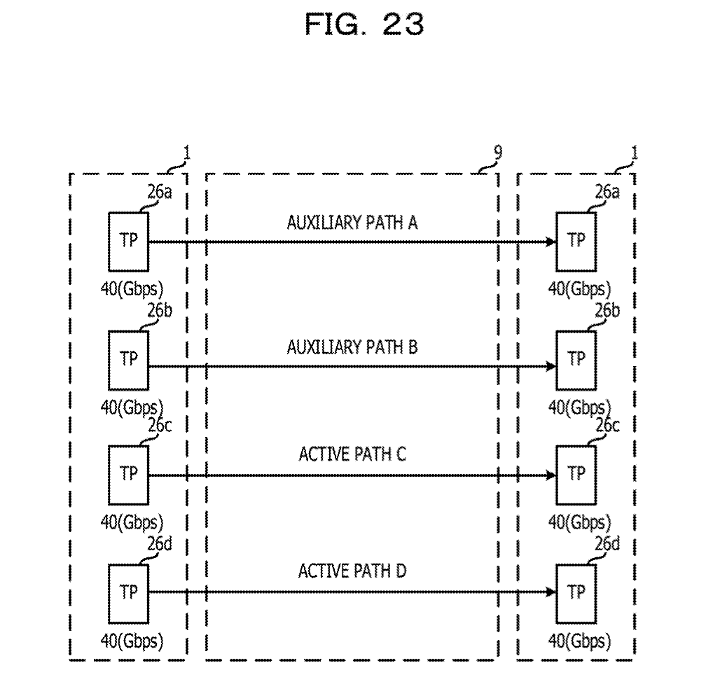

FIG. 23 illustrates an example of the active paths and the auxiliary paths. In this example, two ROADM devices 2 are connected to each other via the optical fiber 9. Each of the ROADM devices 2 includes TPs 26a to 26d having a transmission rate of 40 Gbps. FIG. 23 illustrates only the TPs 26a to 26d as constituent elements of the ROADM devices 2.

Auxiliary paths A and B and active paths C and D are set in a section between the ROADM devices 2. When the path switching is executed, an optical signal is transmitted and received by the TPs 26a of the ROADM devices 2 via the auxiliary path A. In addition, when the path switching is executed, an optical signal is transmitted and received by the TPs 26b of the ROADM devices 2 via the auxiliary path B. An optical signal is transmitted and received by the TPs 26c of the ROADM devices 2 via the active path C. An optical signal is transmitted and received by the TPs 26d of the ROADM devices 2 via the active path D.

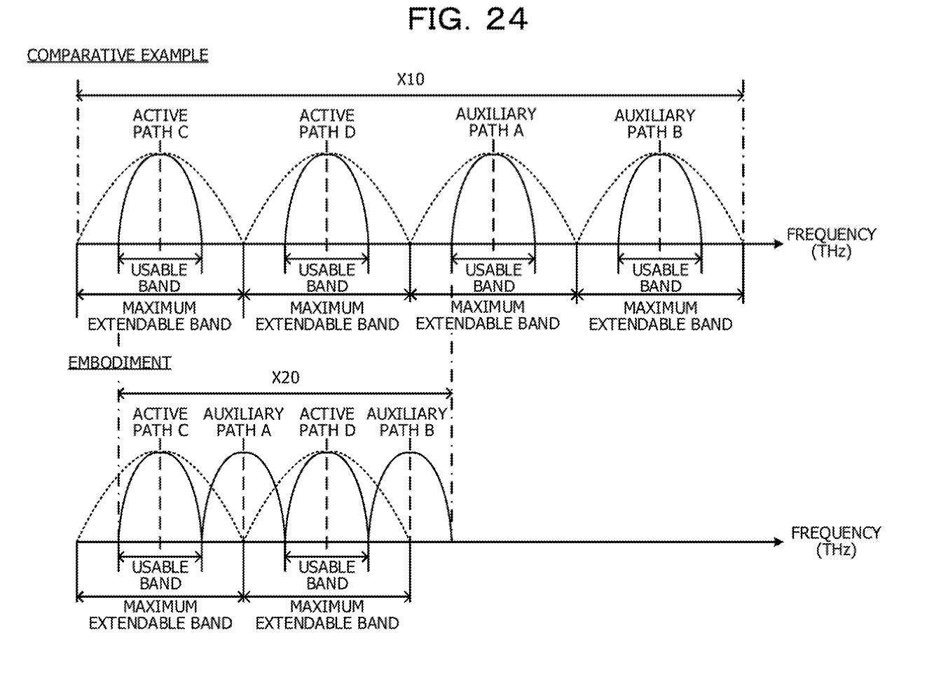

FIG. 24 illustrates allocation states of frequency bands for the active paths C and D and auxiliary paths A and B according to the comparative example and allocations states of frequency bands for the active paths C and D and auxiliary paths A and B according to the embodiment. In the comparative example, usable bands are allocated to the active paths C and D and the auxiliary paths A and B so that the maximum extendable bands for the active paths C and D and auxiliary paths A and B do not overlap each other.

In the embodiment, maximum extendable bands for the auxiliary paths A and B are not ensured and usable bands are allocated to the active paths C and D so that only the maximum extendable bands for the active paths C and D do not overlap each other. In this case, the maximum extendable bands for the active paths C and D are adjacent to each other. An unallocated band that is within the maximum extendable bands for the active paths C and D is allocated to the auxiliary path A. An unallocated band that is within the maximum extendable band for the active path D is allocated to the auxiliary path B.

If each of the bands usable for the auxiliary and active paths A, B, C and D is equal to a half of each of the maximum extendable bands for 40 Gbps, the total X20 of the bands used in the embodiment is a half of the total X10 of the bands used in the comparative example. Thus, since the number of paths used in the embodiment is approximately twice the number of paths used in the comparative example for a predetermined frequency band, the efficiency of using the frequency band is improved in the embodiment.

As described above, the managing server 1 according to the embodiment includes the path determiner 100 and the band manager 101 and manages the network 5 in which wavelength-multiplexed optical signals are transmitted. The path determiner 100 determines an active path and an auxiliary path for each of optical paths.

The band manager 101 allocates, for each of the sections SC1 to SC8 within the network 5, frequency bands for the use of the optical signals to the active paths for the optical signals so that frequency bands for the maximum rates of transmitting the optical signals do not overlap each other. The band manager 101 allocates, for each of the sections SC1 to SC8, unallocated frequency bands within the frequency bands for the maximum transmission rates to the auxiliary paths for the optical signals.

According to the aforementioned configuration, the frequency bands allocated to the auxiliary paths do not overlap the frequency bands allocated to the active paths. Thus, even if an optical signal is transmitted in an auxiliary path due to the path switching upon the occurrence of a failure, an error does not occur in the optical signal, and the communication service is not affected.

If a frequency band allocated to an active path is extended, the extended frequency band overlaps a usable band allocated to an auxiliary path but does not overlap frequency bands allocated to the other active paths. Unless the path switching is executed due to the occurrence of a failure, an optical signal is not transmitted in the auxiliary paths. Thus, frequency bands allocated to the active paths may be extended without an error in optical signals, and the communication service is not affected.

Thus, by allocating unallocated bands within the frequency bands for the maximum transmission rates to the auxiliary paths, the unallocated bands are effectively used and the efficiency of using frequency bands is improved.

The network system according to the embodiment includes the plurality of ROADM devices and the managing server 1. The ROADM devices 2 execute the wavelength multiplexing on multiple optical signals and transmit the optical signals. The managing server 1 manages the network 5 in which the plurality of ROADM devices 2 is installed in the plurality of nodes N1 to N5.

The managing server 1 includes the path determiner 100 and the band manager 101. The path determiner 100 determines an active path and an auxiliary path for each of optical paths.

The band manager 101 allocates, for each of the sections SC1 to SC8 within the network 5, frequency bands for the use of the optical signals to the active paths for the optical signals so that the frequency bands for the maximum rates of transmitting the optical signals do not overlap each other. In addition, the band manager 101 allocates, for each of the sections SC1 to SC8, unallocated frequency bands within the frequency bands for the maximum transmission rates to the auxiliary paths for the optical signals.

The multiple ROADM devices 2 transmit the optical signals in accordance with the allocation of the frequency bands by the band manager 101.

Since the network system according to the embodiment includes the same configuration as the managing server 1, the network system according to the embodiment provides the same effects as the aforementioned details.

A network management method according to the embodiment is a method of managing the network 5 in which multiple wavelength-multiplexed optical signals are transmitted. In the network management method according to the embodiment, the CPU 10 executes the following processes (1) to (3).

In the process (1), the CPU 10 determines an active path and an auxiliary path for each of optical signals.

In the process (2), the CPU 10 allocates, for each of the sections SC1 to SC8 within the network 5, frequency bands to be used for the optical signals to the active paths for the optical signals so that frequency bands for the maximum rates of transmitting the optical signals do not overlap each other.

In the process (3), the CPU 10 allocates, for each of the sections SC1 to SC8, unallocated frequency bands within the frequency bands for the maximum transmission rates to the auxiliary paths for the optical signals.

Since the same configuration as the managing server 1 is used for the network management method according to the embodiment, the network management method according to the embodiment provides the same effects as the aforementioned details.

A network management program according to the embodiment causes the CPU 10 to execute the following processes (1) to (3) in the method of managing the network 5 in which multiple wavelength-multiplexed optical signals are transmitted.

In the process (1), the CPU 10 determines an active path and an auxiliary path for each of optical signals.

In the process (2), the CPU 10 allocates, for each of the sections SC1 to SC8 within the network 5, frequency bands to be used for the optical signals to the active paths for the optical signals so that frequency bands for the maximum rates of transmitting the optical signals do not overlap each other.

In the process (3), the CPU 10 allocates, for each of the sections SC1 to SC8, unallocated frequency bands within the frequency bands for the maximum transmission rates to the auxiliary paths for the optical signals.

Since the same configuration as the managing server 1 is used for the network management program according to the embodiment, the network management program according to the embodiment provides the same effects as the aforementioned details.

The aforementioned process functions may be achieved by a computer. In this case, a program in which details of the processes by the functions included in a processing device are described is provided. The aforementioned process functions are achieved on the computer by the execution of the program by the computer. The program in which the details of the processes are described may be stored in a computer-readable recording medium (however, excluding carrier waves).

If the program is distributed, a portable recording medium storing the program is marketed. The portable recording medium is a digital versatile disc (DVD), a compact disc-read only memory (CD-ROM), or the like, for example. The program may be stored in a storage device of a server computer and transferred from the server computer to another computer via a network.

The computer that executes the program stores, in a storage device of the computer, the program stored in the portable recording medium or transferred from the server computer. Then, the computer reads the program from the storage device of the computer and executes the processes in accordance with the program. The computer may read the program directly from the portable recording medium and execute the processes in accordance with the program. In addition, every time the computer receives the program transferred from the server computer, the computer may sequentially execute the processes in accordance with the received program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A network management method executed by a processor included in a network managing device configured to manage a network in which a plurality of wavelength-multiplexed optical signals is transmitted, the method comprising:
determining an active path and an auxiliary path for each of the plurality of optical signals;
allocating, for each of links coupling adjacent nodes included in the network to each other, frequency bands to be used for the optical signals to the active paths for the optical signals so that frequency bands for the maximum rates of transmitting the optical signals do not overlap each other; and
allocating, for each of the links, unallocated frequency bands within the frequency bands for the maximum transmission rates to the auxiliary paths for the optical signals.

2. The network management method according to claim 1, further comprising:
extending the frequency bands allocated to the active paths; and
changing, when at least a part of the extended frequency bands overlaps a frequency band allocated to an auxiliary path, the frequency band allocated to the auxiliary path so that the frequency band allocated to the auxiliary path does not overlap the extended frequency bands.

3. The network management method according to claim 2,
wherein the changing includes changing the frequency band allocated to the auxiliary path and to be extended so that a frequency band that is higher than the highest frequency band among the frequency bands allocated to and used for the active paths is allocated to the auxiliary path.

4. The network management method according to claim 1,
wherein the changing the frequency band allocated to the auxiliary path includes:
determining, when the frequency band allocated to the auxiliary path is to be extended, whether or not at least a part of the frequency band after the extension overlaps a frequency band allocated to any of the active paths or to another auxiliary path among the auxiliary paths, and
changing, when it is determined that at least a part of the frequency band after the extension overlaps a frequency band allocated to any of the active paths or to another auxiliary path among the auxiliary paths, the frequency band allocated to the auxiliary path and to be extended so that the frequency band after the extension does not overlap the frequency bands allocated to the active paths and the other auxiliary paths.

5. The network management method according to claim 1,
wherein the allocating the frequency bands to the active paths includes allocating, for each of the links, the frequency bands to be used for the optical signals to the active paths for the optical signals so that the frequency bands for the maximum rates of transmitting the optical signals are adjacent to each other.

6. The network management method according to claim 1,
wherein the allocating the frequency bands to the auxiliary paths includes allocating the frequency bands to the auxiliary paths so that each of the frequency bands allocated to the auxiliary paths is adjacent to at least any of the frequency bands allocated to and used for the active paths for the optical signals.

7. The network management method according to claim 1, further comprising
allocating, when a frequency band is to be allocated to a new auxiliary path after the allocation of the frequency bands to the active paths for the optical signals and the allocation of the frequency bands to the auxiliary paths for the optical signals and an unallocated frequency band does not exist between the active paths for the optical signals, an unallocated frequency band included in the highest frequency band among the frequency bands provided for the maximum transmission rates and allocated to the active paths to the new auxiliary path.

8. A network managing device configured to manage a network in which a plurality of wavelength-multiplexed optical signals is transmitted, the network managing device comprising:
a memory; and
a processor coupled to the memory and configured to:
determine an active path and an auxiliary path for each of the plurality of optical signals,
allocate, for each of links coupling adjacent nodes included in the network to each other, frequency bands to be used for the optical signals to the active paths for the optical signals so that frequency bands for the maximum rates of transmitting the optical signals do not overlap each other, and
allocate, for each of the links, unallocated frequency bands within the frequency bands for the maximum transmission rates to the auxiliary paths for the optical signals.

9. The network managing device according to claim 8, wherein the processor is configured to:
extend the frequency bands allocated to the active paths, and
change, when at least a part of the extended frequency bands overlaps a frequency band allocated to an auxiliary path, the frequency band allocated to the auxiliary path so that the frequency band allocated to the auxiliary path does not overlap the extended frequency bands.

10. The network managing device according to claim 9, wherein the processor is configured to
change, when at least a part of the extended frequency bands overlaps a frequency band allocated to an auxiliary path, the frequency band allocated to the auxiliary path and to be extended so that a frequency band that is higher than the highest frequency band among the frequency bands allocated to and used for the active paths is allocated to the auxiliary path.

11. A non-transitory computer-readable recording medium storing a program that causes a processor included in a network managing device to execute a process, the process comprising:
determining an active path and an auxiliary path for each of the plurality of optical signals;
allocating, for each of links coupling adjacent nodes included in the network to each other, frequency bands to be used for the optical signals to the active paths for the optical signals so that frequency bands for the maximum rates of transmitting the optical signals do not overlap each other; and
allocating, for each of the links, unallocated frequency bands within the frequency bands for the maximum transmission rates to the auxiliary paths for the optical signals.

12. The recording medium according to claim 11, wherein the process further comprising:
extending the frequency bands allocated to the active paths; and
changing, when at least a part of the extended frequency bands overlaps a frequency band allocated to an auxiliary path, the frequency band allocated to the auxiliary path so that the frequency band allocated to the auxiliary path does not overlap the extended frequency bands.

13. The recording medium according to claim 12,
wherein the changing includes changing the frequency band allocated to the auxiliary path and to be extended so that a frequency band that is higher than the highest frequency band among the frequency bands allocated to and used for the active paths is allocated to the auxiliary path.
